(19) United States
(12) Patent Application Publication
(10) Pub. No.: US 2013/0342793 A1
(43) Pub. Date: Dec. 26, 2013

(54) LIQUID CRYSTAL DISPLAY DEVICE

(71) Applicant: FUJIFILM Corporation, Tokyo (JP)

(72) Inventors: Jun TAKEDA, Kanagawa (JP); Tatsuya IWASAKI, Kanagawa (JP); Yuki MATSUDA, Kanagawa (JP); Taku WAKITA, Kanagawa (JP); Hiroyuki KAIHOKO, Kanagawa (JP)

(21) Appl. No.: 13/926,237

(22) Filed: Jun. 25, 2013

(30) Foreign Application Priority Data
Jun. 25, 2012 (JP) 2012-142104
Feb. 13, 2013 (JP) 2013-026071

(51) Int. Cl. G02F 1/1335

(52) U.S. Cl. CPC G02F 1/1335
USPC 349/96

(57) ABSTRACT

A liquid crystal display device includes: a first polarizing film; a first retardation region; a liquid crystal cell which includes a liquid crystal layer sandwiched between a pair of substrates, in which liquid crystal molecules in the liquid crystal layer are oriented parallel to surfaces of the pair of substrates at a time of black display; and a second polarizing film, a slow axis of the first retardation region is arranged orthogonally or parallel to a long axis of the liquid crystal molecule at a surface of the liquid crystal layer at a side of the substrate of the liquid crystal cell adjacent to the first retardation region in a state of no application of voltage, the liquid crystal cell operates in a lateral electric field mode, and the first retardation region includes a first retardation layer and a second retardation layer as defined herein.

### FIELD OF THE INVENTION

The present invention relates to a liquid crystal display device of lateral electric field mode, for example, an in-plane switching (IPS) mode, in which display is performed by applying lateral electric field to liquid crystal compounds oriented in the horizontal direction.

### BACKGROUND OF THE INVENTION

A liquid crystal display device of IPS (In-Plane Switching) type or FFS (Fringe Field Switching) type belongs not to a mode which drives according to rising of liquid crystal molecules by applying an electric field between upper and lower substrates as in TN (Twisted Nematic) type or VA (Vertical Alignment) type, but to a system (mode) referred to as a lateral electric field system in which liquid crystal molecules respond in a substrate in-plane direction by an electric field containing a component almost parallel to the substrate surface.

Since the system has theoretically a small limitation on viewing angle based on its structure, it is known as a driving system having a characteristic, for example, a small chromaticity fluctuation or tone change in addition to the wide viewing angle. In recent years, it has begun to spread in various uses from a display device for mobile terminal to high definition and high image quality professional use in addition to TV use.

In the liquid crystal display device of lateral electric field system, a constitution is also known in which by using an isotropic film as a protective film for polarizing plate sandwiching a liquid crystal cell, advantages of the liquid crystal cell can be utilized without harming them (see, for example, JP-A-2010-107953 (the term “JP-A” as used herein means an “unexamined published Japanese patent application”)).

However, since compensation arising from a polarizing film is not considered in the constitution, it is required to perform optical compensation against decrease in contrast or color shift due to light leakage in viewing particularly from an oblique direction. Thus, liquid crystal display devices of lateral electric field system are proposed in which compensation for the display device as a whole is considered by arranging an optically anisotropic layer.

For instance, a retardation film having a stacked structure comprising an oriented film (intermediate layer) containing a polyvinyl alcohol resin and a layer containing rod-like liquid crystal compounds oriented vertically provided on a cellulose acylate film (support) is disclosed in JP-A-2007-279083.

Further, although influence on a retardation resulting from drive of the lateral electric field system is small, since a strong orientation restraining force (anchoring effect) from an oriented film functions on the liquid crystal molecules present in the vicinity of a surface of the oriented film, the orientation of the liquid crystal molecules are not changed by the voltage used in a conventional liquid crystal display device. Specifically, the liquid crystal molecules still oriented parallel to the substrate surface are present in a state where the voltage is applied in order to perform black display. Since the liquid crystal molecules have retardation (residual retardation) to light incident vertically on the liquid crystal layer, it is known that the influence thereof is recognized not a few (see, for example, JP-A-2003-255347).

### SUMMARY OF THE INVENTION

However, it can be seen that the intended compensation effect is not obtained in a high brightness sate by the design of optical compensation of the retardation film described in JP-A-2007-279083.

In order to realize white display at the time of application of voltage (45° direction) in a liquid crystal cell of IPS mode, Δnd (in-plane direction retardation) of approximately λ/2 is ordinarily needed. On the other hand, when the experiment has been performed by assembling a practical liquid crystal cell, it can be understood that the Δnd decreases (declines) at the time of application of voltage to the liquid crystal cell and transmittance at the white display does not become sufficient, even when a retardation (Δnd′) of the liquid crystal cell at the time of no application of voltage (orientation angle of 0°) is set in λ/2 (275 nm). Therefore, the inventors have increased the Δnd′ of the liquid crystal cell in the state of no application of voltage (0°) to adjust the Δnd to λ/2 in the state of white display and as a result it has been found that the transmittance in the state of white display can be achieved but gradation inversion property at the time of grey display and light leakage at a viewing angle of each tint at the time of black display are deteriorated.

This indicates the need for investigation of the residual retardation, which is not assumed in the ideal state, at the time of driving the liquid crystal cell described, for example, in JP-A-2003-255347.

Therefore, in light of the circumstances described above, an object of the invention is to provide a liquid crystal display device in which the gradation inversion property at the time of neutral tone display is improved while restraining the light leakage in the state of black display and which exhibits high contrast by performing design of optical compensation in consideration of the states at the time of white display and at the time of neutral tone display.

As a result of the intensive investigations to solve the problems described above, the inventors have found that although the design of optical compensation is ordinarily studied in the state of black display where no electric field is applied and the drive liquid crystal in the liquid crystal cell is most stable, it is necessary to perform optical compensation in consideration of the state, for example, at the time of white display where the orientation state of the drive liquid crystal is not uniform in comparison with the state at the time of black display on the grounds, for example, the orientation property in the vicinity of interface of the liquid crystal layer or that the electric field in the liquid crystal cell is partially (for example, around the electrode) not oriented parallel to the substrates sandwiching the liquid crystal cell in the state where the electric field is applied, and that the elaborate control in the optical compensation region constituted from plural retardation layers is applied to complete the invention.

Specifically, according to the invention, since a difference between an ideal retardation value Δnd_{w} at the time of white display and a retardation value Δnd_{b} at the time of black display (state of no application of voltage) |Δnd_{b}−Δnd_{w}| is present as a residual retardation, the compensation is performed in consideration of the residual retardation to provide a liquid crystal display device with the optical compensation of high grade. Since in the liquid crystal cell are ordinarily filled with the liquid crystal molecules, the residual retardation in a thickness direction can be expressed by |Δnd_{b}−Δnd_{w}|/2.

The present invention includes the following constitutions.

(1) A liquid crystal display device comprising:
a first polarizing film,
a first retardation region,
a liquid crystal cell which comprises a liquid crystal layer sandwiched between a pair of substrates, in which liquid crystal molecules in the liquid crystal layer are oriented parallel to surfaces of the pair of substrates at a time of black display, and
a second polarizing film,
wherein a slow axis of the first retardation region is arranged orthogonally or parallel to a long axis of the liquid crystal molecule at a surface of the liquid crystal layer at a side of the substrate of the liquid crystal cell adjacent to the first retardation region in a state of no application of voltage,
the liquid crystal cell operates in a lateral electric field mode, and
the first retardation region contains at least a first retardation layer and a second retardation layer having retardation values different from each other and satisfies formulae 1) and 2) shown below:

0.5×(|Rth₁₁|−|Rth₁₂|)≦|Δnd_{b}−Δnd_{w}|/2≦(|Rth₁₁−|Rth₁₂|) Formula 1)

1.3≦|Rth₁₂|/|Re₁₂|+0.5≦1.6 Formula 2)

wherein Δnd_{b} is a retardation value at a wavelength of 550 nm of the liquid crystal cell at a time of black display (in a state of no application of voltage), Δnd_{w} is a retardation value at a wavelength of 550 nm of the liquid crystal cell at a time of white display (in a state of application of voltage), Rth₁₁ is a retardation value at a wavelength of 550 nm in a thickness direction of the first retardation layer constituting the first retardation region, and Re₁₂ and Rth₁₂ are a retardation value at a wavelength of 550 nm in an in-plane direction and a retardation value at a wavelength of 550 nm in a thickness direction of the second retardation layer constituting the first retardation region, respectively.
(2) The liquid crystal display device as described in (1) above, wherein the retardation value of the liquid crystal cell at a time of black display Δnd_{b} satisfies 275 nm<Δnd_{b}<450 nm.
(3) The liquid crystal display device as described in (2) above, wherein the retardation value of the liquid crystal cell at a time of black display Δnd_{b} satisfies 320 nm<Δnd_{b}<400 nm.
(4) The liquid crystal display device as described in any one of (1) to (3) above, wherein the liquid crystal cell satisfies formulae 3) and 4) shown below:

1.0≦Δnd_{b}(450)/Δnd_{b}(550)≦1.6 Formula 3)

0.5≦Δnd_{b}(650)/Δnd_{b}(550)≦1.0 Formula 4)

wherein Δnd_{b}(λ) is a retardation value of the liquid crystal cell at a time of black display at a measuring wavelength λ(nm).
(5) The liquid crystal display device as described in any one of (1) to (4) above, wherein the first retardation layer constituting the first retardation region satisfies formulae 5) and 6) shown below:

1.05≦Rth₁₁(450)/Rth₁₁(550)≦1.15 Formula 5)

0.90≦Rth₁₁(650)/Rth₁₁(550)≦0.98 Formula 6)

wherein Rth₁₁(λ) is a retardation value in a thickness direction of the first retardation layer of the first retardation region at a measuring wavelength λ(nm).
(6) The liquid crystal display device as described in any one of (1) to (5) above, wherein the second retardation layer constituting the first retardation region satisfies formulae 7) and 8) shown below:

0.95≦Rth₁₂(450)/Rth₁₂(550)≦1.10 Formula 7)

0.90≦Rth₁₂(650)/Rth₁₂(550)≦1.05 Formula 8)

wherein Rth₁₂(λ) is a retardation value in a thickness direction of the second retardation layer of the first retardation region at a measuring wavelength λ(nm).
(7) The liquid crystal display device as described in any one of (1) to (6) above, wherein the first retardation layer and second retardation layer each constituting the first retardation region have retardation values satisfying Rth₁₁<0 and Rth₁₂>0, respectively.
(8) The liquid crystal display device as described in any one of (1) to (7) above, wherein the first retardation region containing the first retardation layer and the second retardation layer is constituted by three or more layers intervened with a layer having no retardation.
(9) The liquid crystal display device as described in any one of (1) to (8) above, wherein the first retardation region is constituted by containing three layers of a layer containing a cellulose acylate having an average acyl group substitution degree DS satisfying 2.0<DS<2.6, as a main component, a layer containing a polyvinyl alcohol resin or an acrylic resin having a polar group, and a layer in which a homeotropically oriented liquid crystal compound is fixed in an oriented state.
(10) The liquid crystal display device as described in any one of (1) to (9) above, wherein the first retardation region is a stack having a total thickness of 20 to 50 μm.
(11) The liquid crystal display device as described in any one of (1) to (10) above, wherein a thickness of each of the first polarizing film and the second polarizing film is from 3 to 15 μm.
(12) The liquid crystal display device as described in any one of (1) to (11) above, wherein a protective film is disposed at a side opposite to the liquid crystal cell of the first polarizing film and a total thickness of a polarizing plate comprising the protective film, the first polarizing film and the first retardation region is from 80 to 120 μm.

According to the present invention, optical characteristics suitable to optical compensation at the time of white display of a liquid crystal display device of IPS mode can be provided.

Specifically, the liquid crystal display device according to the invention can provide images of good quality in the state of display of high brightness.

### BRIEF DESCRIPTION OF THE DRAWINGS

FIG. 1 is a schematic cross-sectional view of one example of a liquid crystal display device of IPS type according to the invention.

FIG. 2 is a view schematically showing an example of pixel region applicable to the invention.

FIG. 3 is a schematic cross-sectional view of another example of a liquid crystal display device of IPS type according to the invention.

FIG. 4 is a schematic cross-sectional view of one example of a liquid crystal display device of FFS type according to the invention.

FIG. 5 is a schematic cross-sectional view of another example of a liquid crystal display device of FFS type according to the invention.

### DESCRIPTION OF REFERENCE NUMERALS AND SIGNS

2: Electrode
3: Electrode
4: Rubbing direction of oriented film
5a,5b: Orientation direction of liquid crystal molecule in state of no application of voltage or in state of application of low voltage
6a,6b: Orientation direction of liquid crystal molecule in state of application of voltage
10: Liquid crystal cell
11: First substrate
12: Liquid crystal layer
12a: Slow axis of liquid crystal layer
13: Color filter
14: Electrode
15: Second substrate
20: First polarizing film
20a: Absorption axis of first polarizing film
22: Second polarizing film
22a: Absorption axis of second polarizing film
24: First optical compensation region (first retardation region)
26: Second optical compensation region (second retardation region)
28: Protective film for polarizing plate
30: Backlight unit

### DETAILED DESCRIPTION OF THE INVENTION

Embodiments of the liquid crystal display device according to the invention and constitutive members thereof are described in order below. In the specification, the numerical range indicated with “to” means the range including the numerical values before and after “to” as the lower limit value and upper limit value.

In the specification, the relation between optical axes includes errors acceptable in the technical field to which the invention belongs. Specifically, the term “parallel” or “orthogonal” is meant to fall within a range of less than the strict angle ±10°, preferably within a range of less than the strict angle ±5°, and more preferably within a range of less than the strict angle ±3°. The term “vertical orientation” is meant to fall within a range of less than ±20° from the strict vertical angle, preferably within a range of less than ±15°, and more preferably within a range of less than ±10°. The term “slow axis” means a direction in which the refractive index is the largest.

Although the first retardation region is a stack comprising plural layers in the invention, in case of discussing arrangement relation with the liquid crystal cell, a slow axis in an in-plane direction detected by considering the first retardation region of the stack as a retardation plate of single layer is dealt as the slow axis.

Unless specifically indicated otherwise, the wavelength at which the refractive index is measured is λ=550 nm in a visible light region.

Unless specifically indicated otherwise in the specification, the term “polarizing plate” is meant to include both a long polarizing plate and a polarizing plate cut into a size to be incorporated into a liquid crystal device (in the specification, the term “cutting” is meant to include “blanking” and “cutting out” and the like). In the specification, the terms “polarizing film” and “polarizing plate” are used separately, and the term “polarizing plate” means a stack having on at least one side of “polarizing film”, a transparent protective film to protect the polarizing film.

In the specification, Re(λ) and Rth(λ) represent an in-plane retardation and retardation in a thickness direction at a wavelength λ, respectively. The wavelength λ is 550 nm, unless specifically indicated otherwise in the specification. The Re(λ) is measured by applying light having a wavelength λ nm to a film in the normal direction of the film, using KOBRA 21ADH or WR (produced by Oji Scientific Instruments). The selection of the measurement wavelength λ nm may be conducted according to manual exchange of wavelength selective filter or according to exchange of the measurement value by a program or the like.

In the case where the film to be measured is expressed by a uniaxial or biaxial refractive index ellipsoid, Rth(λ) of the film is calculated in the manner described below.

Six Re(λ) values are measured for incoming light of a wavelength λ nm in six directions which are decided by a 10° step rotation from 0° to 50° with respect to the normal direction of film using an in-plane slow axis (which is decided by KOBRA 21ADH or WR), as an inclination axis (rotation axis) (in the case where the film has no slow axis, an arbitrary in-plane direction of film is defined as the rotation axis), and the Rth(λ) is calculated by KOBRA 21ADH or WR on the basis of the six Re(λ) values measured, a value of hypothetical average refractive index, and a thickness value of the film entered.

In the above calculation, when the film has a retardation value of zero at a certain inclination angle to the normal direction using the in-plane slow axis as the rotation axis, a retardation value at the inclination angle larger than the inclination angle to give a zero retardation is changed to a negative sign, and then the Rth(λ) of the film is calculated by KOBRA 21ADH or WR.

Further, using the slow axis as the inclination axis (rotation axis) (in the case where the film has no slow axis, an arbitrary in-plane direction is defined as the rotation axis), the retardation values are measured in arbitrary inclined two directions, and based on the data, a value of hypothetical average refractive index, and a thickness value of the film entered, Rth can also be calculated according to formulae (1) and (2) shown below.

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Formula ( 1 ) \\ Rth = \{ ( nx + ny ) / 2 - nz \} \times d & Formula ( 2 )\end{matrix}$$

In the formulae above, Re(θ) represents a retardation value in the direction inclined by an angle θ from the normal direction, nx represents a refractive index in the in-plane slow axis direction, ny represents a refractive index in the direction perpendicular to nx in the plane, nz represents a refractive index in the direction perpendicular to nx and ny, and d represents a thickness of film.

In the case where the film to be measured cannot be expressed by a uniaxial or biaxial index ellipsoid, specifically, in the case where the film to be measured has no so-called optical axis (optic axis), Rth(λ) is calculated in the manner described below.

Eleven Re(λ) values are measured for incoming light of a wavelength λ nm in eleven directions which are decided by a 10° step rotation from −50° to +50° with respect to the normal direction of film using an in-plane slow axis (which is decided by KOBRA 21ADH or WR), as an inclination axis (rotation axis), and the Rth(λ) is calculated by KOBRA 21ADH or WR on the basis of the eleven Re(λ) values measured, a value of hypothetical average refractive index, and a thickness value of the film entered.

In the above measurement, as the value of hypothetical average refractive index, values described in Polymer Handbook (JOHN WILEY & SONS, INC.) and catalogs of various optical films can be used. In the case where a value of average refractive index is unknown, the value can be measured by an Abbe refractometer. The average refractive indexes of major optical films are shown below: cellulose acylate (1.48), cycloolefin polymer (1.52), polycarbonate (1.59), polymethyl methacrylate (1.49), and polystyrene (1.59). By entering the value of hypothetical average refractive index and thickness value, nx, ny and nz are calculated by KOBRA 21ADH or KOBRA WR. On the basis of the nx, ny and nz thus-calculated, Nz=(nx−nz)/(nx−ny) is further calculated.

In the specification, the value is obtained by measurement using light having a wavelength of 550 nm under conditions of 25° C. and 60% RH, unless specifically indicated otherwise.

The liquid crystal display device according to the invention is a liquid crystal display device having a first polarizing film, a first retardation region, a liquid crystal cell having a liquid crystal layer sandwiched between a first substrate and a second substrate, and a second polarizing film, wherein liquid crystal molecules contained in the liquid crystal layer are oriented parallel to surfaces of a pair of the substrates at a time of black display, the first retardation region is constituted from plural different retardation layers, and when Δnd_{b} is a retardation value of the liquid crystal cell at a time of black display (in a state of no application of voltage), Δnd_{w} is a retardation value of the liquid crystal cell at a time of white display, Rth₁₁ is a retardation value in a thickness direction of the first retardation layer constituting the first retardation region, and Re₁₂ and Rth₁₂ are retardation values in a in-plane direction and in a thickness direction of the second retardation layer constituting the first retardation region, respectively, formulae 1) and 2) shown below are satisfied.

0.5×(|Rth₁₁|−|Rth₁₂|)≦|Δnd_{b}−Δnd_{w}|/2≦(|Rth₁₁−|Rth₁₂|) Formula 1)

1.3≦|Rth₁₂|/|Re₁₂|+0.5≦1.6 Formula 2)

Embodiments of the liquid crystal display device and respective constitutive members thereof are described in detail below with reference to the drawings.

### [Constitution of Liquid Crystal Display Device]

FIG. 1 is a schematic cross-sectional view of one example of a liquid-crystal display device of IPS type as one embodiment of a liquid-crystal display device of lateral electric field system according to the invention.

The liquid-crystal display device shown in FIG. 1 comprises at least a pair of a first polarizing film 20 and a second polarizing film 22, a first optical compensational region (first retardation region) 24 adjacent to the first polarizing film 20, and an IPS type liquid crystal cell 10.

Also, a second optical compensational region (second retardation region) 26 adjacent to the second polarizing film 22 is provided, if desired. On the surface of the outer side (side opposite to the liquid crystal cell) of the first polarizing film 20 and the second polarizing film 22, protective films for polarizing plate 28 are ordinarily disposed. On the far outer side of the second polarizing film 22, a backlight unit 30 is disposed. The backlight unit 30 may appropriately contain a member, for example, a reflector for increasing utilizing efficiency of light, a brightness-increasing film, a diffuser for converting a point light source or a line light source to a uniform surface light source, a prism sheet or a lens array, as well as a light source.

Further, in addition to the constitution described above, an optically isotropic functional layer, for example, an adhesive or an adhering agent, which is disposed between the first polarizing film 20 and second polarizing film 22, is appropriately used because of no influence on the functional effect of the invention.

### [Liquid Crystal Cell]

In the liquid crystal display device of FIG. 1, the liquid crystal cell 10 has a first substrate 11, a liquid crystal layer 12 composed of a nematic liquid crystal material and a second substrate 15. The liquid crystal layer 12 is a liquid crystal cell of homogeneous orientation in which liquid crystal molecules of the nematic liquid crystal material are oriented parallel to the surface of the pair of substrates 11 and 15 at the time of black display. The product of thickness d (μm) and refractive index anisotropy Δn of the liquid crystal layer, Δn·d is ordinarily approximately from 250 to 400 nm, preferably from 270 to 390 nm, more preferably from 280 to 380 nm, in the transmission mode. When the Δn·d is from 250 to 400 nm, the brightness at a white display is high and the brightness at a black display is low and thus, the display device having brightness and high contrast can be obtained.

That is, Δnd_{b} and/or Δnd_{w} are controlled so as to fall within the range described above.

The Δn·d can be adjusted by controlling Δn and d. Specifically, the cell gap d is preferably more than 2.8 μm and less than 4.5 μm. The cell gap d can be controlled by using, for example, a polymer bead, a glass bead, a fiber or a columnar spacer made of resin. As a liquid crystal material for forming the liquid crystal layer (liquid crystal cell) described above, a nematic liquid crystal having a positive dielectric constant anisotropy Δ∈ can be use. Any of such a nematic liquid crystal may be used without particular restriction. The larger the value of dielectric constant anisotropy Δ∈, the smaller the drive voltage, and the smaller the refractive index anisotropy Δn, the thicker the thickness (gap) of liquid crystal layer, resulting in advantages in that the inclusion time of liquid crystal can be reduced and that the variation in gap can be decreased.

From the standpoint of compatibility between reduction in transmittances in a polarization transmission axis direction and in a vertical direction thereto at a time of black display and retardation of at a time of white display, the retardation value Δnd_{b} of liquid crystal cell at a time of black display preferably satisfies 275 nm<Δnd_{b}<450 nm, and more preferably satisfies 320 nm<Δnd_{b}<400 nm.

Also, in view of the design of optical compensation it is preferred to use a liquid crystal compound exhibiting a wavelength dispersion characteristic satisfying formulae 3) and 4) shown below in the liquid crystal cell.

1.0≦Δnd_{b}(450)/Δnd_{b}(550)≦1.6 Formula 3)

0.5≦Δnd_{b}(650)/Δnd_{b}(550)≦1.0 Formula 4)

In the formulae, Δnd_{b}(λ) is a retardation value of the liquid crystal cell at a time of black display at a measuring wavelength λ.

On the surface of the substrates 11 and 15 adjacent to the liquid crystal layer 12, an oriented film (not shown) is formed by which the liquid crystal molecules are oriented approximately parallel to the surface of the substrate, and in accordance with the direction of the rubbing treatment provided to the oriented film, the orientation direction of the liquid crystal molecules in a state of no application of voltage or in a state of application of low voltage are controlled. On the inner surface of the substrate 11 or 15, a (pixel) electrode 14 capable of applying voltage to the liquid crystal molecules or a color filter 13 is formed.

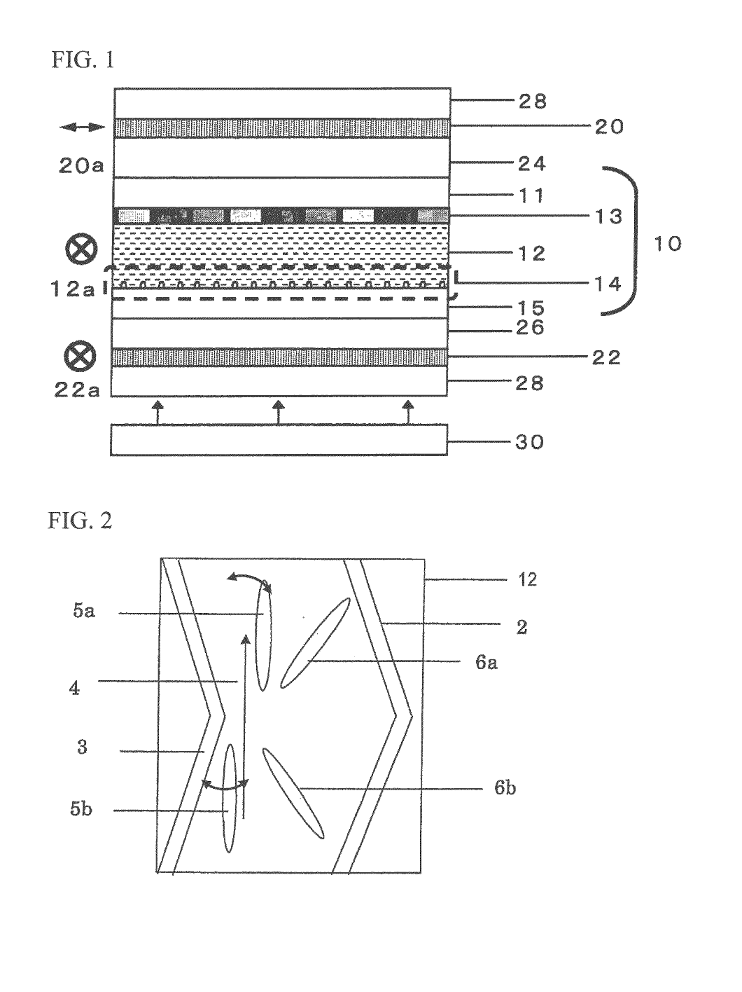

In the liquid crystal layer 12, the liquid crystal molecules are not twisted in a state of no application of voltage, and for example, the molecules are controlled in accordance with the direction of the rubbing treatment of the oriented film formed on the inner surface of the substrates 11 and 15 and are orientated in a certain horizontal direction parallel to the substrates. When voltage is applied thereto, the liquid crystal molecules are rotated horizontally by a predetermined angle due to the electric field formed in the in-plane direction, and are oriented in a predetermined direction. With respect to the form and configuration of the electrode, various proposals are made and any of them can be employed. In FIG. 2, an example of orientation of the liquid crystal molecules in one pixel region of the liquid crystal layer 12 is schematically shown. FIG. 2 is an example of view schematically showing the orientation of liquid crystal molecules in a region of an extremely small area corresponding to one pixel of the liquid crystal layer 12 together with a rubbing direction 4 of the oriented film formed on the inner surface of the substrates 11 and 15 and electrodes 2 and 3 capable of applying voltage to the liquid crystal molecules formed on the inner surface of the substrates 11 and 15. In case of active driving with a nematic liquid crystal having positive dielectric constant anisotropy as a field-effect type liquid crystal, the orientation direction of liquid crystal molecules alignment directions in a state of no application of voltage or in a state of application of low voltage are 5a and 5b, and at this time a black display is obtained. When voltage is applied between the electrodes 2 and 3, the liquid crystal molecules change their orientation directions toward the directions 6a and 6b in accordance with the voltage applied. Ordinarily, at this stage a white display is obtained.

Due to the principle of operation described above the liquid crystal cell preferably has a retardation value of λ/2 plate, and it is particularly preferred in the invention that the Δnd_{w} is designed so as to be 275 nm.

With respect to the constitution of liquid crystal cell, there are known a multi-domain system having regions where the orientations or driving directions of liquid crystal molecules are different in pixel and a single domain system having a single region. The effect of the invention exhibits a tendency of improvement in the gradation inversion or the like not only in the single domain system but also in the multi-domain system.

However, since some of the liquid crystal molecules in liquid crystal layer have a certain degree of pre-tilt angle, they do not form a completely horizontal orientation state and as to an axis inclined from the normal direction, the orientation state of liquid crystal is asymmetry. Further, when an electric field is applied at other than the time of black display, since the electric field applied has locally a part where the electric field are not parallel to the substrate, the orientation state of liquid crystal molecules is tends to form a state depart from the ideal state at the time of application of electric field and thus, there is fear that residue of retardation due to presence or absence of the application of electric field. According to the invention, the optical compensation is performed in consideration of the residual retardation.

The liquid crystal display device according to the invention has a liquid crystal cell of lateral electric field system (preferably IPS type or FFS type). The liquid crystal cells of lateral electric field system are described in various references and any constitution described therein may be appropriately applied to the invention. With respect to the liquid crystal display device of IPS type, reference can be made to descriptions, for example, in JP-A-2003-15160, JP-A-2003-75850, JP-A-2003-295171, JP-A-2004-12730, JP-A-2004-12731, JP-A-2005-106967, JP-A-2005-134914, JP-A-2005-241923, JP-A-2005-284304, JP-A-2006-189758, JP-A-2006-194918, JP-A-2006-220680, JP-A-2007-140353, JP-A-2007-178904, JP-A-2007-293290, JP-A-2007-328350, JP-A-2008-3251, JP-A-2008-39806, JP-A-2008-40291, JP-A-2008-65196, JP-A-2008-76849 and JP-A-2008-96815.

The liquid crystal cell of FFS type (hereinafter, also referred to as FFS mode) has a counter electrode and a pixel electrode. These electrodes are made of a transparent substance, for example, ITO, and are spaced from each other by a distance therebetween narrower than the distance between the upper and lower substrates in such a manner that all the liquid crystal molecules and the like disposed above the electrode can be driven. Due to the constitution, the FFS mode can provide an aperture ratio higher than that in the IPS mode, and in addition, since the electrode part is light transmissive, the FFS mode can attain a higher transmittance than the IPS mode. With respect to the liquid crystal cell of FFS mode, reference can be made to descriptions, for example, in JP-A-2001-100183, JP-A-2002-14374, JP-A-2002-182230, JP-A-2003-131248 and JP-A-2003-233083.

### [Arrangement of Optical Compensation Region]

Again FIG. 1 is referred to, in which an absorption axis 20a of the first polarizing film 20 and an absorption axis 22a of the second polarizing film 22 are disposed orthogonally to each other. At the time of no application of voltage, the liquid crystal molecules of the liquid crystal layer 12 are horizontally oriented so that the slow axis 12a of the liquid crystal layer 12 is parallel to the absorption axis 22a of the second polarizing film 22. Therefore, the incident light from the backlight unit 30 passes through the liquid crystal layer 12 while almost maintaining the polarization state thereof and is blocked by the absorption axis 20a of the first polarizing film 20 to provide a black state. However, the incident light from the backlight unit 30 that has come in the device in an oblique direction brings about light leakage since the absorption axes 20a and 22a of the polarizing films 20 and 22 are deviated from the orthogonal relationship, thereby resulting in reduction of the viewing angle contrast. The same phenomenon arises also in the case of viewing in an oblique direction. The first optical compensation region 24 disposed between the first polarizing film 20 and the liquid crystal cell 10 has a function of reducing the light leakage to improve the viewing angle contrast. The function of improvement is to compensate the deviated orthogonal relationship by utilizing the function of λ/2 plate as described above and an optically anisotropic layer having the function may be used without particular restriction and a in-plane retardation in the case where the first optical compensation region 24 is regarded as a single layer retardation plate is preferably from 100 to 250 nm, more preferably from 140 to 230 nm, and particularly preferably from 190 to 210 nm.

The retardation in a thickness direction is preferably from −150 to 10 nm, more preferably from −100 to −10 nm, and particularly preferably from −50 to −30 nm. The range of retardation in a thickness direction described above is preferred, because the light leakage and tint change at the time of black display are reduced to improve the view angle characteristic. The first optical compensation region 24 is described in detail hereinafter.

The second optical compensation region 26 may be provided between the second polarizing plate 22 and the second substrate 15.

In the case where the optical compensation according to the first optical compensation region 24 has no problems, the second optical compensation region 26 is not needed to have an optical function and thus, an isotropic film having no retardation so as not to function to light or an optically anisotropic film having a low retardation value may be disposed as a protective film for polarizing plate, or a constitution may be made wherein the second optical compensation region 26 is not disposed at all, for example, wherein the second polarizing film 22 is stacked directly on the second substrate 15.

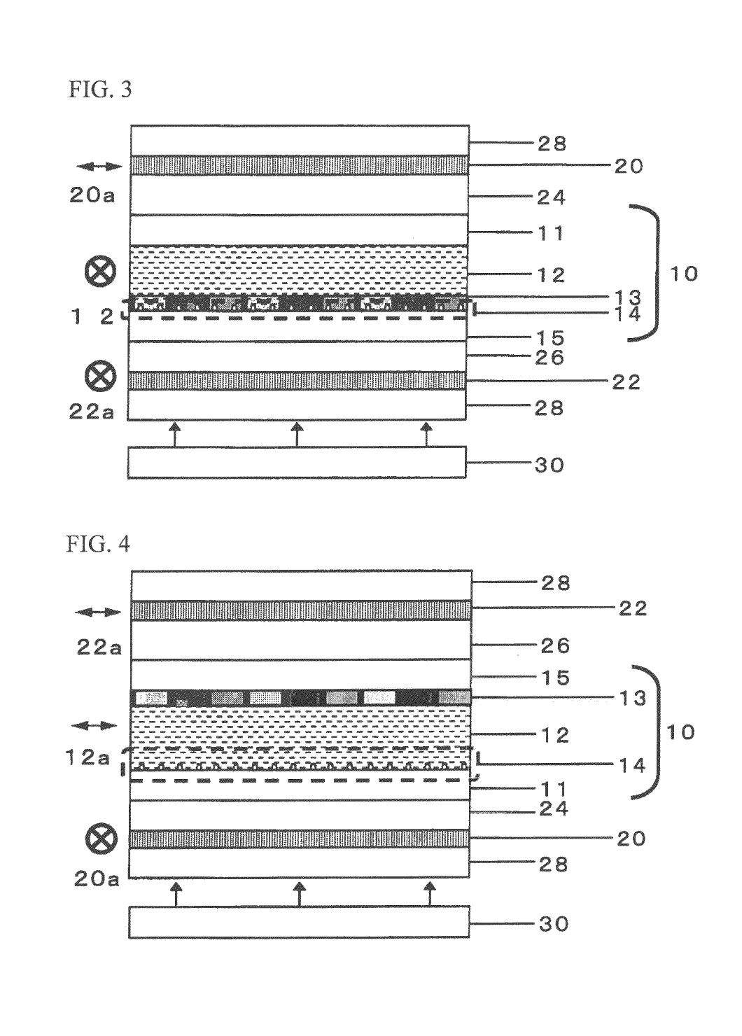

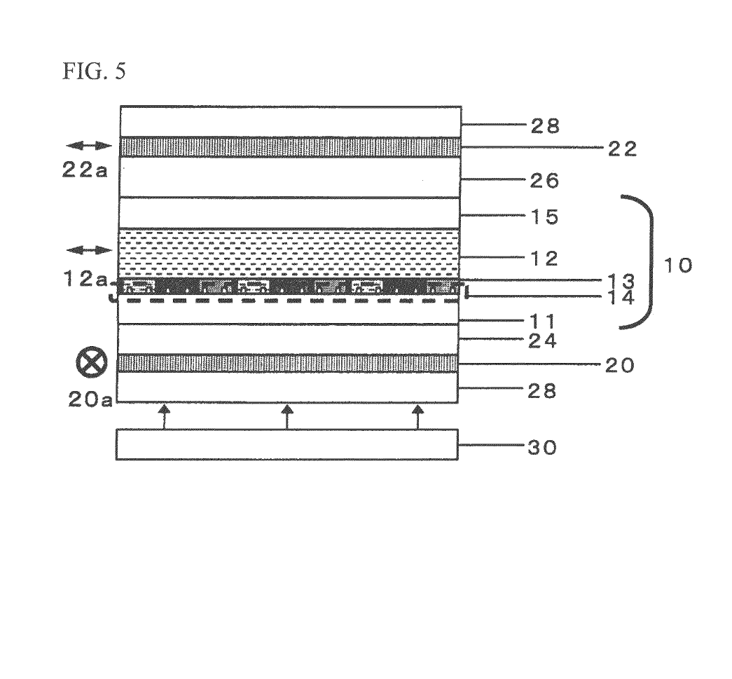

Although the constitution of liquid crystal display device wherein the liquid crystal cell 10 in FIG. 1 is the IPS mode is shown, as a derivative constitution, a constitution of COA (Color-filter On Array) in which an optical member, for example, a color filter is stacked to an electrical function as shown in FIG. 3 may be made. Also, in the case where the liquid crystal cell 10 is the FFS mode described above, a constitution shown in FIG. 4 or FIG. 5 is made as an ordinary constitution because the slow axis direction at the time of black display is in an orthogonal direction to the IPS mode. Although the arrangement of constitution is partially replaced, since the effects obtained according to the invention are not changed, the descriptions will be made without particular differentiation hereinafter.

Preferred optical characteristics of members, for example, the first optical compensation region capable of using in the liquid crystal display device according to the invention, and materials for using in the members and method for producing thereof are described in detail below.

### [First Optical Compensation Region]

The first optical compensation region (first retardation region) is a stack constituted from plural retardation layers containing at least a first retardation layer and a second retardation layer having retardation values different from each other. In the case where not only the elaborate control in the retardation value but also control in desired characteristics, for example, a wavelength dispersion characteristic are made, it is extremely difficult to use a single layer in view of design and the desired characteristics of the first optical compensation region can be attained by a combination of plural retardation layers constituted based on the functional separation.

When the first optical compensation region is constituted by plural different retardation layers and satisfies formulae 1) and 2) shown below, the effect of disappearance or reduction of the residual retardation is attained.

0.5×(|Rth₁₁|−|Rth₁₂|)≦Δnd_{b}−Δnd_{w}|/2≦(|Rth₁₁|−|Rth₁₂|) Formula 1)

1.3≦|Rth₁₂|/|Re₁₂|+0.5≦1.6 Formula 2)

In the formulae, Δnd_{b} is a retardation value of the liquid crystal cell at a time of black display (in a state of no application of voltage), Δnd_{w} is a retardation value of the liquid crystal cell at a time of white display, Rth₁₁ is a retardation value in a thickness direction of the first retardation layer constituting the first retardation region, and Re₁₂ and Rth₁₂ are a retardation value in an in-plane direction and a retardation value in a thickness direction of the second retardation layer constituting the first retardation region, respectively.

With respect to the first optical compensation region, the material and configuration thereof are not particularly restricted as far as the optical characteristics described above are attained. For instance, any of a retardation film made of a birefringent polymer film, a film obtained by coating a polymer compound on a transparent support and heating, and a retardation film having a retardation layer formed by coating or transferring a low molecular weight or high molecular weight liquid crystal compound on a transparent support may be used. Alternatively, a stack produced by stacking these films may be used.

The combination relating to the optical characteristics is also not restricted, and various constitutions, for example, a combination of two layers composed of a biaxial film having nx>nz>ny (B-plate) and a semi-uniaxial film having nx≈ny>nz (negative C-plate), a combination of two layers composed of a biaxial film having nx>ny>nz (B-plate) and a semi-uniaxial film having nx≈ny<nz (positive C-plate), a combination of a biaxial film having nx>nz>ny and a biaxial film having nx>ny>nz, A-plate and negative C-plate, A-plate, or positive C-plate and A-plate may be exemplified. From the standpoint other than the optical design, a small number of the layers is preferred because when a number of layers is large, the increase of interface has concerns for decrease in utilization efficiency of light due to reflection or scattering at the interface and decrease in production aptitude due to increase in the number of steps in the production thereof, and for the purpose of contributing to reduction of thickness of the display device.

As to the reduction of thickness of the first retardation region, a thickness of the stack is preferably from 20 to 50 μm, and a thickness of the polarizing plate having the first retardation region in combination with a polarizing film of 3 to 15 μm and a protective film provided on the opposing surface is preferably from 80 to 120 μm.

As to the combination of retardation layers, the combination of two layers composed of a biaxial film having nx>ny>nz (B-plate) and a semi-uniaxial film having nx≈ny<nz (positive C-plate) is preferably used from the standpoint of optical design, production aptitude, selection of materials or the like.

The first retardation layer constituting the first retardation region preferably has a wavelength dispersion characteristic satisfying formulae 5) and 6) shown below.

The second retardation layer constituting the first retardation region preferably has a wavelength dispersion characteristic satisfying formulae 7) and 8) shown below. They are preferably effective to restrain a color shift regarding the wavelength dispersion characteristic.

1.05≦Rth₁₁(450)/Rth₁₁(550)≦1.15 Formula 5)

0.90≦Rth₁₁(650)/Rth₁₁(550)≦0.98 Formula 6)

0.95≦Rth₁₂(450)/Rth₁₂(550)≦1.10 Formula 7)

0.90≦Rth₁₂(650)/Rth₁₂(550)≦1.05 Formula 8)

In the formulae, Rth₁₁(λ) is a retardation value in a thickness direction of the first retardation layer of the first retardation region at a measuring wavelength λ(nm), and Rth₁₂(λ) is a retardation value in a thickness direction of the second retardation layer of the first retardation region at a measuring wavelength λ(nm).

From the standpoint of the light leakage and tint change in the mounting configuration, the first retardation layer and second retardation layer each constituting the first retardation region preferably have retardation values satisfying Rth₁₁<0 and Rth₁₂>0, respectively.

From the standpoint of adhesion property between the first retardation layer and second retardation layer, the first retardation region containing the first retardation layer and second retardation layer is preferably constituted by three or more layers intervened with a layer having no retardation.

In particular, the first retardation region is preferably constituted by containing three layers of a layer (hereinafter, also referred to as a “support”) containing a cellulose acylate having an average acyl group substitution degree DS satisfying 2.0<DS<2.6, as a main component, a layer (hereinafter, also referred to as an “intermediate layer”) containing a polyvinyl alcohol resin or an acrylic resin having a polar group, and a layer (hereinafter, also referred to as a “retardation layer”) in which a homeotropically oriented liquid crystal compound is fixed in an oriented state.

The retardation layer described above corresponds to the first retardation layer and the support described above corresponds to the second retardation layer.

As a specific example of the first retardation region comprising the combination of two layers composed of a biaxial film having nx>ny>nz (B-plate) and a semi-uniaxial film having nx≈ny<nz (positive C-plate), a constitution wherein a cellulose acylate film used as the biaxial film is combined with a retardation layer in which a rod-like liquid crystal compound is homeotropically oriented and then fixed used as the positive C-plate is described below.

The constitution is specifically a stack comprising a biaxial film composed of cellulose acylate and a retardation layer in which a composition containing a rod-like liquid crystal compound is coated and orientation state of the liquid crystal compound is fixed.

The stack is constituted by providing on a biaxial film (B-plate) of 20 to 50 μm having Re₁₂ of 80 to 150 nm, Rth₁₂ of −100 to 10 nm and |Rth/Re| of 0.8 to 1.1, a retardation layer of a semi-uniaxial film (positive C-plate) of 0.5 to 2.0 μm having Re₁₁ of −10 to 10 nm and Rth₁₁ of −250 to −100 nm.

The stack composed of two layers forms the first retardation region which exhibits characteristics acting as Re of 100 to 250 nm and Rth of −150 to 10 nm.

### [Support]

The support is preferably a cellulose acylate film.

### [Cellulose Acylate Film]

The cellulose acylate include a cellulose acylate compound and a compound having an acyl-substituted cellulose skeleton which is obtained by introducing biologically or chemically a functional group into cellulose as a starting material.

The cellulose acylate is an ester of cellulose and an acid. The acid constituting the ester is preferably an organic aid, more preferably a carboxylic acid, still more preferably a fatty acid having from 2 to 22 carbon atoms, and most preferably a lower fatty acid having from 2 to 4 carbon atoms.

### [Acyl Substitution Degree of Cellulose Acylate Film]

The cellulose acylate according to the invention is a compound obtained by acylation of hydroxy group of cellulose.

The cellulose acylate according to the invention preferably contains cellulose acylate having an average acyl group substitution degree DS satisfying 2.00<DS<2.60 as a main component.

In the case where the cellulose acylate is composed of a single polymer, the term “as a main component” means the polymer and in the case where the cellulose acylate is composed of plural polymers, the term “as a main component” means a polymer having a highest mass fraction in the plural polymers.

The measurement of substitution degree of hydroxy group of cellulose in the cellulose acylate is not particularly restricted and a bonding degree of acetic acid and/or a fatty acid having from 3 to 22 carbon atoms substituted with hydroxy groups of cellulose is measured to obtain the substitution degree by calculation. The measurement can be performed by a method according to ASTMD-817-91.

When the acyl substitution degree of cellulose acylate is represented by DS, DS preferably satisfies 2.00<DS<2.60, more preferably satisfies 2.00<DS<2.50, still more preferably satisfies 2.10<DS<2.50, and particularly preferably satisfies 2.20<DS<2.45.

The acyl substitution degree larger than 2.00 is preferred in view of attaining sufficient moisture stability and sufficient durability of polarizing plate. The acyl substitution degree smaller than 2.60 is preferred because the cellulose acylate excellent in expression of optical characteristics, solubility in an organic solvent and compatibility with a polycondensation product which may be used as an additive is obtained.

The acyl group included in the cellulose acylate is not particularly restricted, and may be an aliphatic acyl group or an aromatic acyl group and may be alone or a mixture of two or more kinds thereof. A number of carbon atoms of the acyl group is preferably from 2 to 22 and particularly preferably 2 or 3. The acyl group includes, for example, an alkylcarbonyl ester group, an alkenylcarbonyl ester group, an aromatic carbonyl ester group or an aromatic alkylcarbonyl ester group of cellulose and these groups may further have a substituted group. Preferred examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. Among them, an acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are preferred, and an acetyl group, a propionyl group and a butanoyl group are more preferred. An acetyl group and a propionyl group are still more preferred, and an acetyl group is most preferred.

### [Production of Cellulose Acylate Film]

The support included in the retardation film which can be used in the invention is preferably a cellulose acylate film containing the cellulose acylate described above.

The method for production of a cellulose acylate film preferably comprises a film forming step wherein a dope is cast on a support and a solvent is evaporated to form a cellulose acylate film, a stretching step wherein the film is stretched, a drying step wherein the film is dried, and after the completion of the drying step, a step wherein the film is subjected to heat treatment at temperature of 150 to 200° C. for at least one minute.

### (Film Forming Step)

In the invention, known film forming methods of cellulose acylate film or the like can be widely employed and the production according to a solution casting film forming method is preferred. According to the solution casting film forming method, a film is produced by using a solution (dope) prepared by dissolving cellulose acylate in an organic solvent.

The organic solvent preferably contains a solvent selected from an ether having from 3 to 12 carbon atoms, a ketone having from 3 to 12 carbon atoms, an ester having from 3 to 12 carbon atoms and a halogenated hydrocarbon having from 1 to 6 carbon atoms. The ether, ketone and ester may have a cyclic structure. A compound having any two or more functional groups of ether, ketone and ester (that is, —O—, —CO— and —COO—) can also be used as the organic solvent. The organic solvent may have other functional group, for example, an alcoholic hydroxyl group. In case of the organic solvent having two or more kinds of functional groups, the number of the carbon atoms included may fall within a range of the number of carbon atoms included in the compound having any of the functional groups.

Examples of the ether having from 3 to 12 carbon atoms include diisopropyl ether, dimethoxymethane, dimethoxyethane, 1,4-dioxane, 1,3-dioxolane, tetrahydrofuran, anisole and phenetole.

Examples of the ketone having from 3 to 12 carbon atoms include acetone, methyl ethyl ketone, diethyl ketone, diisobutyl ketone, cyclohexanone and methylcyclohexanone.

Examples of the ester having from 3 to 12 carbon atoms include ethyl formate, propyl formate, pentyl formate, methyl acetate, ethyl acetate and pentyl acetate.

Examples of the organic solvent having two or more kinds of functional groups include 2-ethoxyethyl acetate, 2-methoxyethanol and 2-butoxyethanol.

The number of carbon atoms included in the halogenated hydrocarbon is preferably 1 or 2, and most preferably 1. The halogen atom in the halogenated hydrocarbon is preferably a chlorine atom. The proportion of the hydrogen atom in the halogenated hydrocarbon substituted with a halogen atom is preferably from 25 to 75% by mole, more preferably from 30 to 70% by mole, still more preferably from 35 to 65% by mole, and most preferably from 40 to 60% by mole. Methylene chloride is a typical halogenated hydrocarbon.

Two or more kinds of organic solvents may be used as a mixture.

The cellulose acylate solution can be prepared according to an ordinary method. In anordinary method, the solution is processed at a temperature not lower than 0° C. (room temperature or high temperature). The preparation of the solution can be carried out using a method and an apparatus for preparation of dope in an ordinary solution casting film forming method. In the ordinary method, a halogenated hydrocarbon (particularly, methylene chloride) is preferably used as the organic solvent.

The amount of the cellulose acylate is so controlled that it may be contained in the solution in an amount from 10 to 40% by weight. The amount of the cellulose acylate is preferably from 10 to 30% by weight in the solution. To the organic solvent (main solvent), an appropriate additive described hereinafter may be added.

The solution is prepared by stirring a cellulose acylate and an organic solvent at normal temperature (0 to 40° C.). The solution having high concentration may be stirred under pressure and heating. Specifically, a cellulose acylate and an organic solvent are put into a pressure chamber, sealed and stirred therein under pressure while heating at a temperature within a range from a boiling point of the solvent at normal temperature to a temperature at which the solvent does not boil. The heating temperature is ordinarily 40° C. or more, preferably from 60 to 200° C., and more preferably from 80 to 110° C.

From the cellulose acylate solution (dope) prepared, a cellulose acylate film can be produced by a solution casting film forming method.

The dope is cast on a drum or a band and a solvent is evaporated to form a film. In the dope before casting, the concentration is preferably controlled so that the solid content thereof is from 18 to 35% by weight. The surface of the drum or band is preferred to be finished in a mirror surface. Casting and drying methods in solution casting film forming method are described in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554(the term “JP-B” as used herein means an “examined Japanese patent publication”), JP-B-49-5614, JP-A-60-176834, JP-A-60-203430 and JP-A-62-115035.

The dope is preferably cast on a drum or band having a surface temperature of 10° C. or less. After the casting, it is preferred to dry with air for at least 2 seconds. The film formed is peeled from the drum or band and then it may be dried with high temperature air of which the temperature is stepwise changed from 100 to 160° C. to remove the residual solvent by vaporization. The method above is described in JP-B-5-17844. According to the method, the time to be taken from the casting to the peeling may be shortened. In order to carry out the method, the dope must be gelled at the surface temperature of the drum or band on which it is cast.

### (Co-Casting)

The cellulose acylate film which can be used in the invention is preferably that produced by stretching after the formation of film by the solution casting film forming method. Also, the solution casting film formation is preferably a simultaneous or successive multilayer cast film formation according to a co-casting method. The reason for this is that a film having the desired retardation value is obtained.

In the invention, the cellulose acylate solution prepared may be cast onto a smooth band or drum serving as a metal support, as a single layer solution or plural cellulose acylate solutions for 2 or more layers may be co-cast thereon. In the case where plural cellulose acylate solutions are co-cast, the cellulose acylate solutions may be respectively cast on a metal support through plural casting apertures disposed at intervals in the traveling direction of metal support to stack on the support, thereby forming a film. For example, methods described in JP-A-61-158414, JP-A-1-122419 and JP-A-11-198285 are employed. The cellulose acylate solution may be cast through two casting apertures to form a film and, for example, methods described in JP-B-60-27562, JP-A-61-94724, JP-A-61-947245, JP-A-61-104813, JP-A-61-158413 and JP-A-6-134933 are employed. Also, a casting method of cellulose acylate film wherein a flow of a high viscosity cellulose acylate solution is enveloped with a low viscosity cellulose acylate solution and the resulting high viscosity and low viscosity cellulose acylate solutions are simultaneously extruded described in JP-A-56-162617 may be employed. Further, an embodiment wherein a surface side solution contains a larger amount of alcohol as a poor solvent than in an inner side solution described in JP-A-61-94724 or JP-A-61-94725 is preferred.

Alternatively, a film may be formed by using two casting apertures wherein a film is formed on a metal support through a first casting aperture and then peeled and a second casting is conducted on the surface of the film brought into contact with the metal support through a second casting aperture. For example, method described in JP-B-44-20235 is employed. The cellulose acylate solutions to be cast may be the same or different from each other and are not particularly restricted. In order to make the plural cellulose acylate layers have various functions, cellulose acylate solutions corresponding to the desired functions may be cast through the respective casting apertures. The cellulose acylate solution which can be used in the invention may be cast simultaneously with other functional layer (for example, an adhesive layer, a dye layer, an antistatic layer, an antihalation layer, an UV absorbing layer or a polarizing layer).

In the case of using a single layer solution according to a conventional technique, a high concentration and high viscosity cellulose acylate solution is preferably extruded in order to achieve the desired thickness of film. In such a case, however, the stability of the cellulose acylate solution is poor to generate a solid material, thereby often causing problems, for example, occurrence of failure due to foreign material or deterioration of planarity. For solving the problems, casting of plural cellulose acylate solutions through different casting apertures makes it possible to extrude high density solutions at the same time on a metal support and as a result, the planarity is improved and a film having the excellent surface property can be produced. In addition, since the thick cellulose acylate solution can be used, the reduction of drying load can be achieved and the production speed of film can be increased.

According to the case of co-casting, a cellulose acylate film of a stack structure can be produced by co-casting cellulose acylate solutions in which the substitution degree of cellulose acylate differs.

Moreover, cellulose acylate solutions in which concentration of additive, for example, a plasticizer, an ultraviolet absorbing agent or a fine particle differs are co-cast to produce a cellulose acylate film having a stack structure. For example, the fine particle may be incorporated in a larger amount into the surface layer or may be only incorporated into the surface layer. The plasticizer and ultraviolet absorbing agent may be incorporated in a large amount into the inner layer than into the surface layer, or may be only incorporated into the inner layer. The kind of the plasticizer or ultraviolet absorbing agent may differ between the inner layer and the surface layer. For example, a low volatile plasticizer and/or ultraviolet absorbing agent may be incorporated into the surface layer, and a plasticizer of excellent plasticity or an ultraviolet absorbing agent of excellent ultraviolet absorbing property may be added to the inner layer. An embodiment of incorporating a release agent only into the surface layer on the side of the metal support is also preferred. In order to gel the solution by cooling of the metal support in a cooling drum method, an alcohol as a poor solvent is preferably added to the surface layer in a larger amount than to the inner layer. The Tg may differ between the surface layer and the inner layer, and the Tg of the inner layer is preferably lower than that of the surface layer. The viscosity of the cellulose acylate solution to be cast may differ between the surface layer and the inner layer, and the viscosity of the solution for the surface layer is preferably smaller than that for the inner layer, but, the viscosity of the solution for the inner layer may be smaller than that for the surface layer.

The support is preferably a support of a stack composed of cellulose acylate having the average acyl group substitution degree DS satisfying 2.0<DS<2.6 and cellulose acylate having the average acyl group substitution degree from 2.6 to 3.0 from the standpoint of peeling from the metal support.

### (Thickness of Film)

The thickness of cellulose acylate film as the support of the retardation film which can be used in the invention is preferably from 10 to 80 μm, more preferably from 20 to 60 μm, and still more preferably from 20 to 40 μm. The thickness of 10 μm or more is preferred in view of a handling property at the time of processing into a polarizing plate or the like and curl inhibition of a polarizing plate. Also, unevenness in thickness of the cellulose ester film which can be used in the invention is preferably from 0 to 2%, more preferably from 0 to 1.5%, particularly preferably from 0 to 1%, in any of the transportation direction and the width direction.

### (Haze of Film)

The haze of the cellulose acylate film or retardation film which can be used in the invention is preferably from 0.01 to 1.0%, more preferably from 0.05 to 0.8%, and still more preferably from 0.1 to 0.7%. The film of high transparency is preferred as an optical film because an amount of light from a light source can be utilized without any loss of light. The haze of the film is measured using a haze meter HGM-2DP (produced by Suga Test Instruments Co., Ltd.) in accordance with JIS K-6714.

### (Dimensional Change of Film)

With respect to the dimensional stability of the cellulose acylate film which can be used in the invention, both a dimensional change rate in the case of allowing the film to stand under the condition of 60° C. and 90% RH for 24 hours (at high humidity) and a dimensional change rate in the case of allowing the film to stand under the condition 80° C. and 5% RH for 24 hours (at high temperature) are preferably 0.5% or less, more preferably 0.3% or less, and still more preferably 0.15% or less.

### (Additive)

The support of the retardation film which can be used in the invention contains at least one compound selected from the group consisting of i) and ii) shown below.

The addition of the compound makes adjustments of moisture permeability and water content due to impartation of hydrophobicity and adjustments of mechanical properties due to impartation of plasticity easy.

i) Polycondensate ester containing a dicarboxylic acid residue having an average carbon number of 5.5 to 10.0 containing at least one aromatic dicarboxylic acid residue, and

ii) Sugar ester containing from 1 to 12 pyranose structures or furanose structures in which at least one of the hydroxy groups is esterified with an aromatic ester.

The compound i) or ii) has a function of a plasticizer and when the retardation film comprising the cellulose acylate film wherein the compound i) or ii) is added to the cellulose acylate having the average acyl group substitution degree DS satisfying 2.00<DS<2.60 described above is used as a protective film for polarizing plate, durability of the polarizing plate is improved.

### [i) Polycondensate Ester]

The polycondensate ester i) containing a dicarboxylic acid residue having an average carbon number of 5.5 to 10.0 containing at least one aromatic dicarboxylic acid residue is a compound obtained from at least one dicarboxylic acid containing an aromatic ring (also referred to as an aromatic dicarboxylic acid) and at least one diol.

As to specific constitutions and characteristics of the polycondensate ester, descriptions in Paragraph Nos. [0039] to [0054] of JP-A-2012-56995 can be referred to.

The content of the polycondensate ester in the cellulose acylate film is preferably from 1 to 30% by weight, more preferably from 3 to 25% by weight, still more preferably from 5 to 20% by weight, to the cellulose acylate.

### [ii) Sugar Ester]

The sugar ester ii) containing from 1 to 12 pyranose structures or furanose structures in which at least one of the hydroxy groups is esterified with an aromatic ester (also referred to as “ii) sugar ester”) is described below.

By adding the sugar ester compound to the cellulose acylate film, the internal haze is not deteriorated when the film is subjected to a moisture and heat treatment after stretching without impairing the optical characteristics exhibiting property. Further, in the case of employing the cellulose acylate film which can be used in the invention in a liquid crystal display device, in-plane contrast can be greatly improved.

As to specific constitutions and characteristics of the sugar ester, descriptions in Paragraph Nos. [0100] to [0124] of JP-A-2012-56995 can be referred to.

The content of the sugar ester compound in the cellulose acylate film is preferably from 2 to 30% by weight, more preferably from 3 to 25% by weight, still more preferably from 5 to 20% by weight, to the cellulose acylate.

In the case where an additive having a negative intrinsic birefringence described hereinafter is used together with the sugar ester compound, the amount of the sugar ester compound added (part by weight) to the amount of the additive having a negative intrinsic birefringence (part by weight) is preferably from 2 to 10 times (ratio by weigh), and more preferably from 3 to 8 times (ratio by weight).

Also, in the case where a polyester plasticizer described hereinafter is used together with the sugar ester compound, the amount of the sugar ester compound added (part by weight) to the amount of the polyester plasticizer (part by weight) is preferably from 2 to 10 times (ratio by weigh), and more preferably from 3 to 8 times (ratio by weight).

The sugar ester compounds may be used individually or in combination of two or more thereof.

Various low molecular weight or polymer additives (for example, a deterioration preventing agent, an ultraviolet preventing agent, a retardation (optical anisotropy) adjusting agent, a peeling accelerator, an infrared absorbing agent or a fine particle) may be added to the cellulose acylate film depending on the intended use at any step of the production thereof. The additive may be a solid or oily material. That is, the melting point or boiling point thereof is not particularly restricted. With respect to examples of the specific compounds, descriptions in Paragraph Nos. [0055] to [0099] of JP-A-2012-56995 can be referred to. The timing of the addition thereof may be at any time during a preparation step of cellulose acylate solution (dope) and the addition may also be conducted by introducing a step of adding the additive to prepare a dope at the final stage of the dope preparation step. The amount of each additive added is not particularly restricted as far as the function is exhibited. In the case where the cellulose acylate resin layer is composed of plural layers, the kind and amount of the additive added may be varied.

### (Retardation Exhibiting Agent)

In order to exhibit the retardation, a compound having at least two aromatic rings can be used as a retardation exhibiting agent.

The compound having at least two aromatic rings preferably exhibits an optically positive uniaxiality when it is uniformly oriented and a compound in which the two aromatic rings form a rigid part and which further expresses liquid crystallinity.

The molecular weight of the compound having at least two aromatic rings is preferably from 300 to 1,200, and more preferably from 400 to 1,000.

In order to regulate optical characteristics, particularly, Re to a preferred value, stretching is effective. For the purpose of raising the Re, it is necessary to increase the refractive index anisotropy within the film plane, and one method thereof is to enhance the orientation of a main chain of the polymer film by stretching. Also, by using a compound having a large refractive index anisotropy as an additive, it is possible to further raise the refractive index anisotropy of the film. For example, in the compound having at least two aromatic rings, when a force by which the polymer main chains are arranged travels due to the stretching, the orientation property of the compound is enhanced, whereby it becomes easy to regulate the film so as to have the desired optical characteristics.

Examples of the compound having at least two aromatic rings include triazine compounds described in JP-A-2003-344655, rod-like compounds described in JP-A-2002-363343, and liquid crystalline compounds described in JP-A-2005-134884 and JP-A-2007-119737. The triazine compounds and rod-like compounds are more preferred.

Two or more kinds of the compounds having at least two aromatic rings may be used in combination.

The support preferably contains a compound represented by formula (IIIA) or (IIIB) shown below as the retardation exhibiting agent. By containing the compound represented by formula (IIIA) or (IIIB), the optical characteristics exhibiting property per unit layer thickness increases to contribute the reduction of layer thickness.

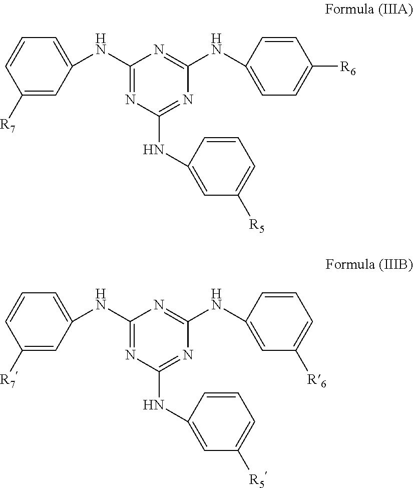

In formulae (IIIA) and (IIIB), R₅ to R₇ each independently represents —OCH₃ or —CH₃, and R₅′ to R₇′ each independently represents —OCH₃ or —CH₃.

The amount of the compound having at least two aromatic rings added to the cellulose acylate film is preferably from 0.05 to 10%, more preferably from 0.5 to 8%, still more preferably from 1 to 5%, in terms of weight ratio to the cellulose acylate.

### [Other Additives]

To the cellulose acylate film, in addition, an additive, for example, an antioxidant, a peeling accelerator or a fine particle can be added.

### (Antioxidant)

In order to prevent degradation, for example, depolymerization due to oxidation, an antioxidant can be used in the retardation film according to the invention. The antioxidant which can be used includes phenol or hydroquinone antioxidants and phosphorus antioxidants described in Paragraph No. [0120] of JP-A-2012-181516. The amount of the antioxidant added to the cellulose acylate film is preferably from 0.05 to 5.0 parts by weight based on 100 parts by weight of the cellulose acylate.

### (Peeling Accelerator)

As an additive for reducing a peeling resistance of the cellulose acylate film from a metal support for casting, many surfactants are known to exhibit the remarkable effect. As the preferred peeling accelerator, a phosphoric acid ester surfactant, a carboxylic acid or carboxylate surfactant, a sulfonic acid or sulfate surfactant or a sulfuric acid ester surfactant is effective. Also, a fluorinated surfactant in which hydrogen atoms bonded to a hydrocarbon chain of the surfactant described above are partially substituted with fluorine atoms is effective.

As to specific examples thereof, compounds described in the item of “Organic acid” of Paragraph Nos. [0124] to [0138] of JP-A-2012-181516 can be referred to.

The amount of the peeling accelerator added to the cellulose acylate film is preferably from 0.05 to 5% by weight, more preferably from 0.1 to 2% by weight, most preferably from 0.1 to 0.5% by weight to the cellulose acylate.

### (Fine Particle)

Into the retardation film according to the invention, a fine particle can be incorporated from the standpoint of a film slipping property and production stability. The fine particle may be referred to as a mat agent and may be an inorganic compound or an organic compound.

As to preferred examples of the fine particle, fine particles described in the item of “Mat agent fine particle” of Paragraph Nos. [0024] to [0027] of JP-A-2012-177894 and the item of “Mat agent” of Paragraph Nos. [0122] to [0123] of JP-A-2012-181516 can be referred to as specific examples thereof.

Since the fine particle is smaller than a wavelength of light, the haze of film increases only when the fine particle is added in a large amount and an disadvantage, for example, reduction of contrast or occurrence of bright spot is hardly caused in case of the practical use in LCD. When the amount thereof is not too small, the creak is prevented and the scratch resistance is attained. In view of the above, the content of the fine particle is preferably in a range from 0.01 to 5.0% by weight, more preferably in a range from 0.03 to 3.0% by weight, particularly preferably in a range from 0.05 to 1.0% by weight to the cellulose acylate film.

### [Intermediate Layer]

In case of stacking two retardation layers, an appropriate layer may intervene between the retardation layers in order to improve the adhesion property between the retardation layers and regulate state of interface (surfaces at the time of stacking) (hereinafter, the layer is referred to as an intermediate layer).

The intermediate layer is preferably a layer containing a polyvinyl alcohol resin or an acrylic resin having a polar group.

### (Polyvinyl Alcohol Resin)

As a material for the intermediate layer, a polyvinyl alcohol resin may be used. As the polyvinyl alcohol resin, a modified or unmodified polyvinyl alcohol may be used.

The material may be selected from known materials for the horizontal oriented film as well as known materials for the vertical oriented film. The modified or unmodified polyvinyl alcohol has been also used as the vertical oriented film, and by adding an onium compound described hereinafter to the composition for forming the retardation layer, the liquid crystal molecule may be homeotropically oriented at the intermediate layer interface due to the interaction between the onium compound and the intermediate layer, the interaction between the onium compound and the liquid crystal compound, and the like. Of the modified polyvinyl alcohols, the intermediate layer containing a polyvinyl alcohol having a unit of a polymerizable group is preferably used, because the adhesion property to the retardation layer is more improved.

Polyvinyl alcohols having at least one hydroxy group substituted with a group having a oxiranyl moiety or an aziridinyl moiety are preferred and, for example, modified polyvinyl alcohols described in the paragraphs [0071] to [0095] of Japanese Patent No. 3,907,735 are preferred.

### (Acrylic Resin Having Polar Group)

As a material for the intermediate layer, an acrylic resin having a polar group may also be used. The case of forming the intermediate layer using the acrylic resin having a polar group is preferred in view of productivity, because a sufficient adhesion property can be obtained even when a cellulose acylate film as the support is not subjected to a saponification treatment and thus the production process of retardation film can be simplified.

The acrylic resin having a polar group is preferably a resin containing a repeating unit derived from a compound having a polar group and a (meth)acryloyl group.

In the invention, an acryloyl group and a methacryloyl group are collectively referred to as a “(meth)acryloyl group”.

The polar group indicates that difference of electronegativity of two atoms connecting with each other is large, and specifically includes at least one polar group selected from the group consisting of a hydroxy group, a carbonyl group, a carboxyl group, an amino group, a nitro group, an ammonium group and a cyano group. Particularly, a hydroxy group is preferred.

The acrylic resin having a polar group according to the invention may contain a repeating unit having no polar group or may contain a repeating unit other than the repeating unit derived from a compound having a (meth)acryloyl group.

From the standpoint of increase in the adhesion property to the support layer, the acrylic resin having a polar group is preferably a resin containing a repeating unit derived from a compound having three or more functional groups per molecule and a repeating unit derived from a compound having a polar group and one (meth)acryloyl group.

### (Compound Having Three or More Functional Groups Per Molecule)

The compound having three or more functional groups per molecule includes compounds having a polymerizable functional group (polymerizable unsaturated double bond), for example, a (meth)acryloyl group, a vinyl group, a styryl group or an allyl group and is preferably a compound having a (meth)acryloyl group or —C(O)OCH═CH₂. Compounds having three or more (meth)acryloyl groups per molecule described below is particularly preferred.

Specific examples of the compound having a polymerizable functional group include a di(meth)acrylate of alkylene glycol, a di(meth)acrylate of polyoxyalkylene glycol, a di(meth)acrylate of a polyhydric alcohol, a di(meth)acrylate of ethylene oxide or propylene oxide adduct, an epoxy(meth)acrylate, a urethane(meth)acrylate and a polyester(meth)acrylate.

Among them, an ester of a polyhydric alcohol and (meth)acrylic acid is preferred. For example, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacrylate and caprolactone-modified tris(acryloxyethyl) isocyanurate are exemplified.

As the compound having three or more functional groups per molecule, commercially available products may also be used. For example, as the polyfunctional acrylate compound having a (meth)acryloyl group, KAYARAD PET30, KAYARAD DPHA, KAYARAD DPCA-30 and KAYARAD DPCA-120 produced by Nippon Kayaku Co., Ltd. are exemplified. As the urethane acrylate, U15HA, U4HA and A-9300 produced by Shin-Nakamura Chemical Co., Ltd. and EB5129 produced by Daicel UCB Co., Ltd. are exemplified.

The intermediate layer is particularly preferably a layer containing an acrylic resin having a polar group, wherein the acrylic resin layer is a layer in which an acrylic monomer is crosslinked upon light or heat, and the polar group is a hydroxy group. Thus, the intermediate layer makes it possible that rod-like liquid crystal compounds are effectively oriented homeotropically in the retardation layer.

### (Formation Method of Intermediate Layer)

The intermediate layer can be formed by coating a composition for forming the intermediate layer directly or through other layer on a cellulose acylate film as the support and drying.

In the case where the material for the intermediate layer is the polyvinyl alcohol resin, a solvent which contains water or an alcoholic solvent as the main component and to which an organic solvent is appropriately added is preferably used.

In the case where the material for the intermediate layer is the acrylic resin having a polar group, a solvent having property capable of dissolving cellulose acylate or a solvent having property capable of swelling cellulose acylate is preferably used.

As the solvent having property capable of swelling cellulose acylate swells the cellulose acylate film, a compound forming the acrylic resin having a polar group penetrates into the cellulose acylate film. Also, the solvent having property capable of dissolving cellulose acylate dissolves the cellulose acylate film to diffuse the cellulose acylate into the intermediate layer. Thus, the cellulose acylate film exhibits excellent adhesion property to the intermediate layer even when it is not subjected to a saponification treatment.

### [Solvent Having Property Capable of Dissolving Cellulose Acylate]

The solvent having property capable of dissolving cellulose acylate means a solvent having such a property that when a cellulose acylate film having a size of 24 mm×36 mm (thickness: 80 μm) is immersed in a 15 cm³ bottle having the solvent charged therein at room temperature (25° C.) for 60 seconds and taken out, and then the immersed solution is analyzed by means of gel permeation chromatography (GPC), a peak area of the cellulose acylate is 400 mV/sec or more. Alternatively, the solvent having property capable of dissolving cellulose acylate means also a solvent having such a property that when a cellulose acylate film having a size of 24 mm×36 mm (thickness: 80 μm) is allowed to elapse in a 15 cm³ bottle having the solvent charged therein at room temperature (25° C.) for 24 hours, followed by appropriately swinging the bottle or the like, the film is completely dissolved to lose its form.

The solvent having property capable of dissolving cellulose acylate may be used individually or in combination of two or more thereof.

The solvent having property capable of dissolving cellulose acylate includes, for example, methyl acetate, acetone and methylene chloride, and is preferably methyl acetate or acetone.

### [Solvent Having Property Capable of Swelling Cellulose Acylate]

The solvent having property capable of swelling cellulose acylate means a solvent having such a property that when a cellulose acylate film having a size of 24 mm×36 mm (thickness: 80 μm) is put vertically into a 15 cm³ bottle having the solvent charged therein to immerse at room temperature (25° C.) for 60 seconds and observed while appropriately swinging the bottle, bending or deformation is found (in the film, the size of the swollen portion thereof changes to be observed as bending or deformation, whereas in case of a solvent having no property capable of swelling cellulose acylate, a change, for example, bending or deformation is not found).

As the solvent having property capable of swelling cellulose acylate, solvents described in Paragraph No. [0026] of JP-A-2008-112177 may be employed.

For instance, an ether having from 3 to 12 carbon atoms, for example, dibutyl ether or tetrahydrofuran, a ketone having from 3 to 12 carbon atoms, for example, acetone, methyl ethyl ketone, diethyl ketone, cyclopentanone or cyclohexanone, an ester having from 3 to 12 carbon atoms, for example, methyl acetate or ethyl acetate, or an organic solvent having two or more kinds of functional groups is used. The solvents having property capable of swelling cellulose acylate may be used individually or in combination of two or more thereof.

Further, in order to control the effects of the solvent described above, a solvent having neither property capable of dissolving cellulose acylate nor property capable of swelling cellulose acylate may be used together.

As the solvent having neither property capable of dissolving cellulose acylate nor property capable of swelling cellulose acylate, solvents described in Paragraph No. [0027] of JP-A-2008-112177 are employed.

Examples of the solvent include methyl isobutyl ketone (MIBK), methanol, ethanol, 1-butanol, 2-butanol, tert-butanol, 1-pentanol, 2-propanol, 2-methyl-2-butanol, cyclohexanol, 2-octanone, 2-pentanone, 2-hexanone, 2-heptanone, 3-pentanone, 3-heptanone, 4-heptanone and isobutyl acetate.

As the solvent, a solvent having neither property capable of dissolving cellulose acylate nor property capable of swelling cellulose acylate may be used, and the amount of the solvent having neither property capable of dissolving cellulose acylate nor property capable of swelling cellulose acylate is preferably 90% by weight or less, more preferably 85% by weight or less, and still more preferably 80% by weight or less.

From the standpoint of swelling of the support and increase in the adhesion property, the solvent preferably contains at least one of methyl acetate, acetone and methyl ethyl ketone. The solvent is preferably a mixed solvent containing methyl acetate or acetone and methyl ethyl ketone.

From the standpoint of taking balance between adequate solubility of the support and the adhesion property, a ratio of the content of the solvent having property capable of dissolving cellulose acylate or property capable of swelling cellulose acylate and the solvent having no property capable of swelling cellulose acylate is preferably from 10:90 to 60:40.

With respect to the total amount of the solvents in the composition for forming the intermediate layer, the solid content concentration in the composition is preferably from 1 to 70% by weight, more preferably from 2 to 50% by weight, and still more preferably from 3 to 40% by weight.

The retardation film according to the invention preferably has a mixed layer containing the main composition of the support and the main composition of the intermediate layer between the support and the intermediate layer, and the thickness of the mixed layer is preferably from 0.3 to 5.0 μm and more preferably from 0.5 to 4 μm.

The presence of the mixed layer enhance the adhesion property between the support and the intermediate layer. It is preferred that the thickness of the mixed layer is 0.3 μm or more because of the sufficient adhesion property and that the thickness of the mixed layer is 5.0 μm or less because the concentration distribution in the mixed layer does not cause phase separation and the contrast does not decrease when mounted on the liquid crystal panel.

The thickness measurement of the mixed layer can be conducted by cutting the cross section thereof in the thickness direction using microtome, staining with osmic acid and then observing the cross section by using SEM.

The mixed layer can be formed by incorporating the solvent having property capable of dissolving cellulose acylate or property capable of swelling cellulose acylate into the composition for forming the intermediate layer. The thickness of the mixed layer can be controlled by selecting the kind and concentration of the solvent having property capable of dissolving cellulose acylate or property capable of swelling cellulose acylate.

[Retardation Layer in which Orientation State of Liquid Crystal Compound is Fixed (Retardation Layer)]

The retardation layer in which the orientation state of liquid crystal compound is fixed (retardation layer) contained in the retardation film which can be used in the invention is described below.

The retardation layer is a layer in which the state of homeotropic orientation of liquid crystal compound is fixed.

The homeotropic orientation is an orientation state wherein the liquid crystal molecules are oriented in the normal direction of the layer and the slow axis is parallel to the normal direction of the layer. Although it is particularly preferred that the slow axis of the retardation layer is parallel to the normal direction of the layer, it may have a tilt according to the orientation state of liquid crystal molecules. The tilt is preferably 3.5° or less because the in-plane retardation can be controlled to 10 nm or less.

### (Liquid Crystal Compound)

As to the liquid crystal compound, from the standpoint of optical characteristics of the retardation film, a layer in which the homeotropic orientation of the composition containing a rod-like liquid crystal compound as the main component is fixed is preferred.

The layer in which the homeotropic orientation of the rod-like liquid crystal compound is fixed can function as a positive C-plate.

With respect to the rod-like liquid crystal compound usable, there are descriptions in Paragraph Nos. [0045] to [0066] of JP-A-2009-217256 and they can be referred to. With respect to the additive usable in the retardation layer, the oriented film usable and the formation method of the homeotropic liquid crystal layer according to the invention, there are descriptions in Paragraph Nos. [0076] to [0079] of JP-A-2009-237421 and they can be referred to.

From the standpoint of exhibiting the optical characteristics, the liquid crystal compound for forming the retardation layer is preferably at least one compound selected from the group consisting of a compound represented by formula (IIA) shown below and a compound represented by formula (IIB) shown below.

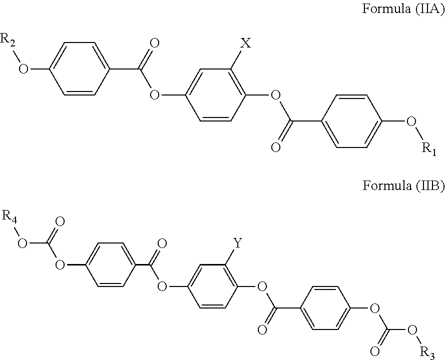

In formulae (IIA) and (IIB), R₁ to R₄ each independently represents —(CH₂)ₙ—OOC—CH═CH₂, n represents an integer from 1 to 5, and X and Y each independently represents a hydrogen atom or a methyl group.

From the standpoint of preventing the crystal deposition, each of X and Y in formulae (IIA) and (IIB) preferably represents a methyl group. From the standpoint of exhibiting the property as the liquid crystal, n is preferably an integer from 1 to 5.

Further, from the standpoint of preventing the crystal deposition, the content of the liquid crystal compound for forming the retardation layer in the retardation layer is preferably 70% by weight or more, and particularly preferably 80% by weight or more. In the case where the compound represented by formula (IIA) and the compound represented by formula (IIB) are used as the liquid crystal compound, the contents thereof are preferably 3% by weight or more, more preferably 5% by weight or more, particularly preferably 8% by weight or more, based on the total solid content of the retardation layer, respectively.

### (Onium Compound Represented by Formula (I))

The retardation layer contained in the retardation film which can be used in the invention preferably contains an onium compound represented by formula (I) shown below. The onium compound functions as a vertical orientation agent which accelerates the homeotropic orientation of the liquid crystal compound at the oriented film interface and also contributes to the improvement in the adhesion property at the interface between the retardation layer and the intermediate layer. The retardation layer may contain, if desired, an air interface side orientation controlling agent (for example, a copolymer containing a repeating unit having a fluoroaliphatic group) which controls the orientation on the air interface side.

The onium compound represented by formula (I) is added for the purpose of controlling the orientation of the liquid crystal compound at the intermediate layer interface and has a function of increasing the tilt angle of liquid crystal molecule in the vicinity of the intermediate layer interface.

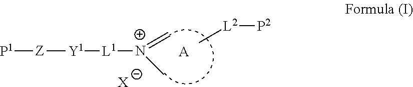

In formula (I), ring A represents a quaternary ammonium ion composed of a nitrogen-containing hetero ring, X represents an anion, L¹ represents a divalent connecting group, L² represents a single bond or a divalent connecting group, Y¹ represents a divalent connecting group containing a 5-membered or 6-membered ring as a partial structure, Z represents a divalent connecting group containing an alkylene group having from 2 to 20 carbon atoms as a partial structure, and P¹ and P² each independently represents a hydrogen atom, a hydroxy group, a carbonyl group, a carboxyl group, an amino group, a nitro group, an ammonium group, a cyano group or a monovalent substituent having a polymerizable ethylenically unsaturated group.

The ring A represents a quaternary ammonium ion composed of a nitrogen-containing hetero ring. Examples of ring forming the ring A include a pyridine ring, a picoline ring, a 2,2′-bipyridyl ring, 4,4′-bipyridyl ring, a 1,10-phenanthroline ring, a quinolone ring, an oxazole ring, a thiazole ring, an imidazole ring, a pyrazine ring, a triazole ring and a tetrazole ring. The quaternary ammonium ion is preferably a quaternary imidazolium ion or a quaternary pyridinium ion.

The onium compound represented by formula (I) includes onium compounds represented by formulae (I-1) and (I-2) shown below.

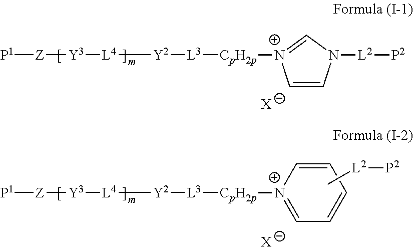

In formulae (I-1) and (I-2), X, L², Z, P¹ and P² have the same meanings as defined in Formula (I) respectively, L³ and L⁴ each independently represents a divalent connecting group, Y² and Y³ each independently represents a 6-membered ring which may have a substituent, m represents 1 or 2, when m is 2, two L⁴ and two Y³ may be the same or different from each other, and p represents an integer from 1 to 10.

The onium compound represented by formula (I) includes onium compounds represented by formulae (I-3) and (I-4) shown below.

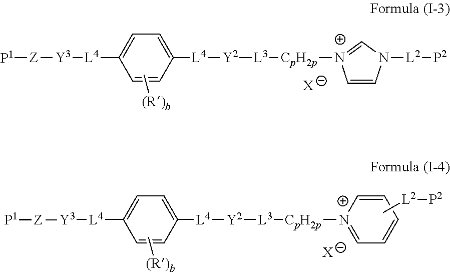

In formulae (I-3) and (I-4), X, L², Z, P¹, P², L³, L⁴, Y², Y³ and p have the same meanings as defined in Formulae (I-1) and (I-2) respectively, R′ represents a substituent, and b represents an integer from 1 to 4.

Examples of the substituent represented by R′ are same as the examples of substituent which the 6-membered ring represented by Y² and Y³ in formulae (I-1) or (I-2) may have, and preferred ranges are also the same. Specifically, R′ is preferably a halogen atom, an alkyl group or an alkoxy group.

b represents an integer from 1 to 4, and is preferably from 1 to 3, and more preferably 2 or 3.

Specific examples of the compound represented by formula (I) are set forth below.

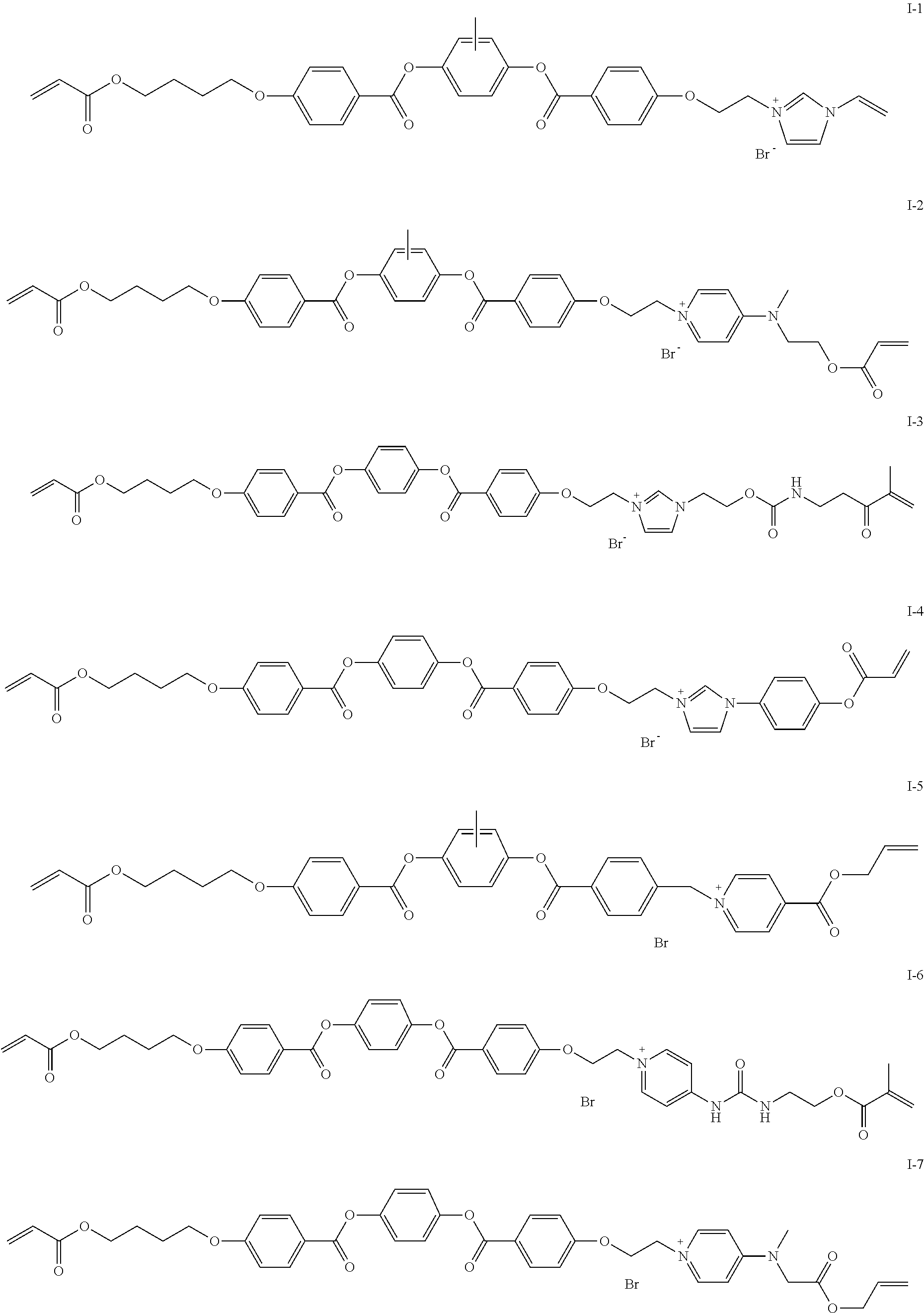

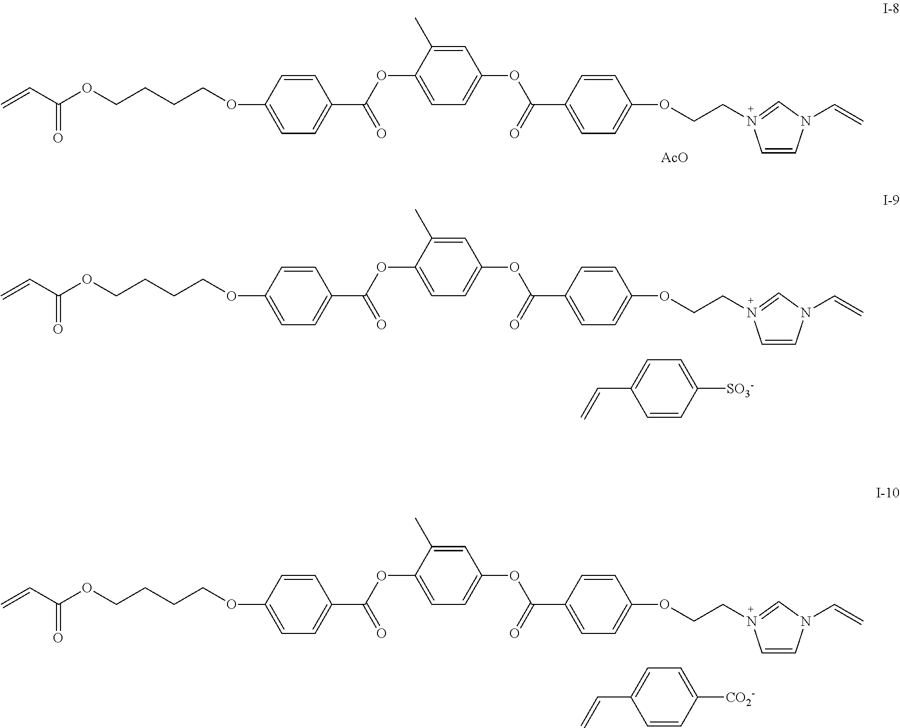

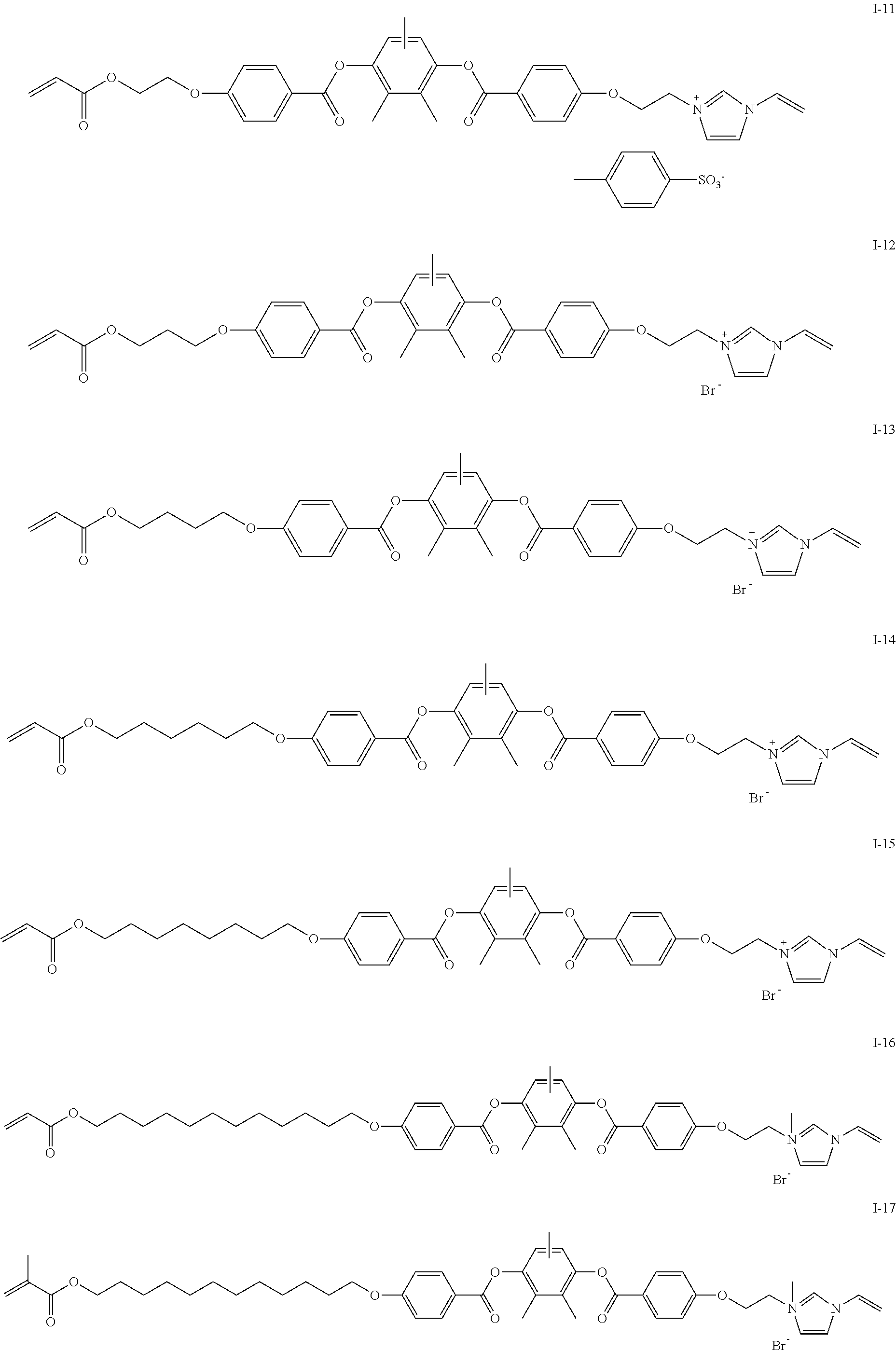

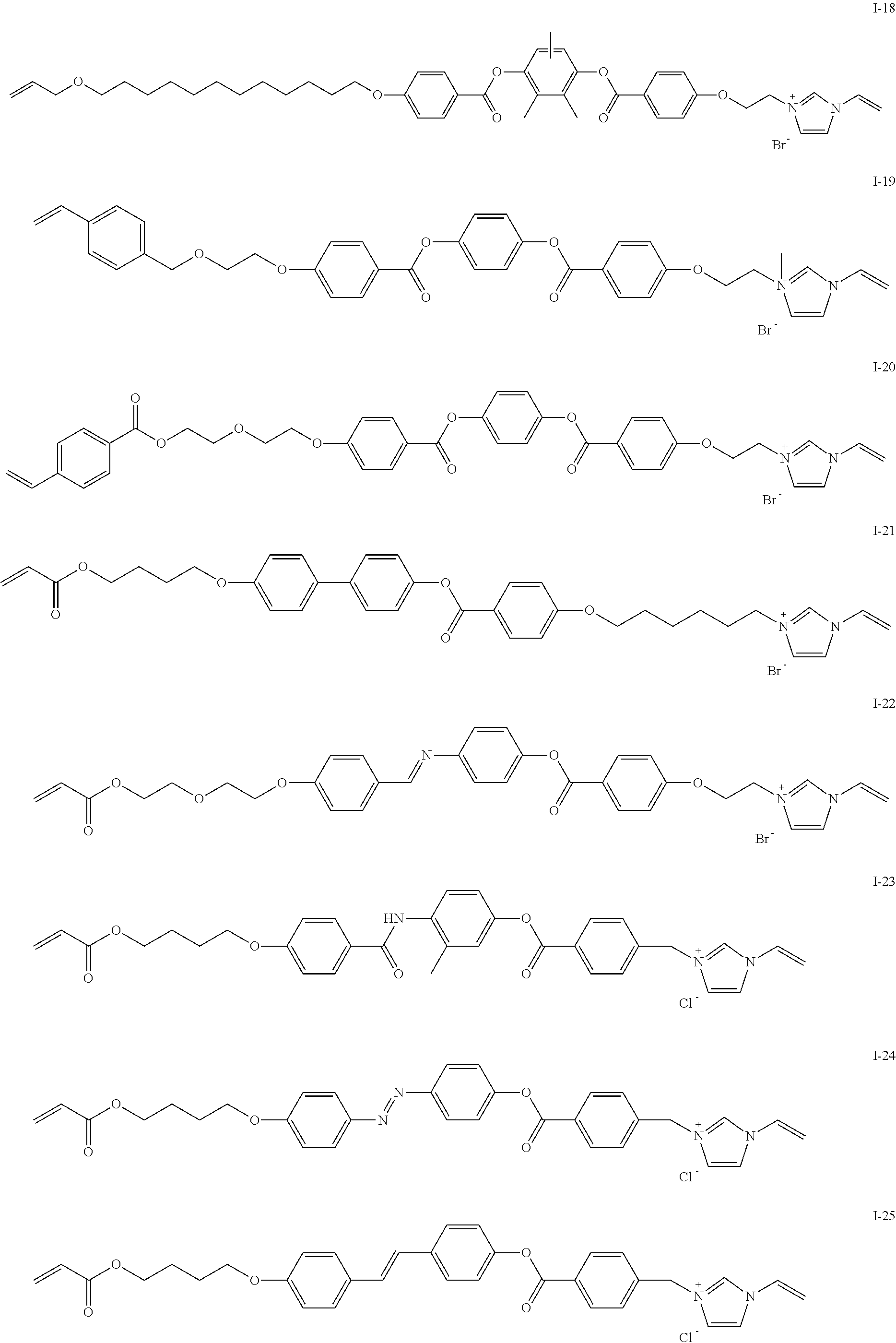

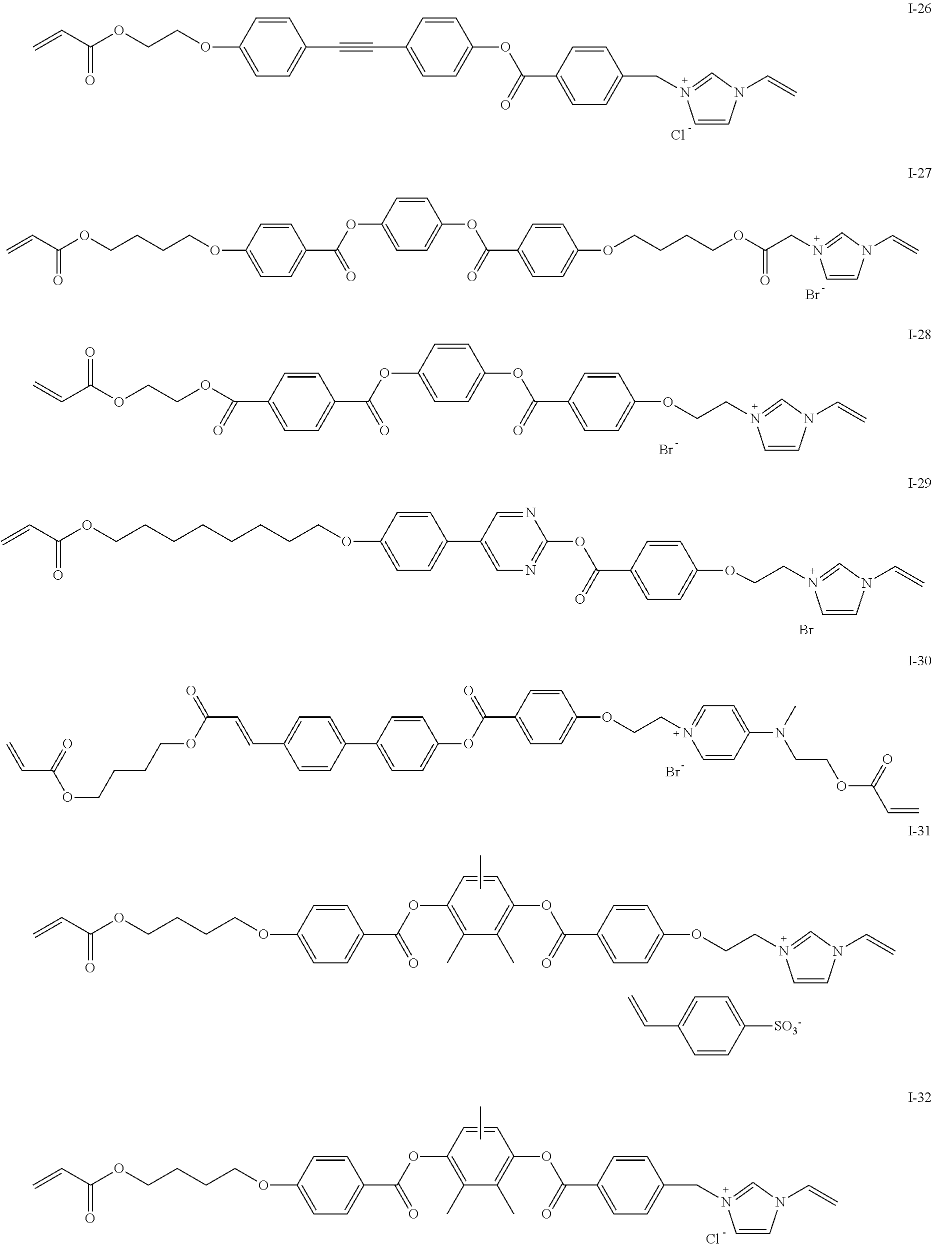

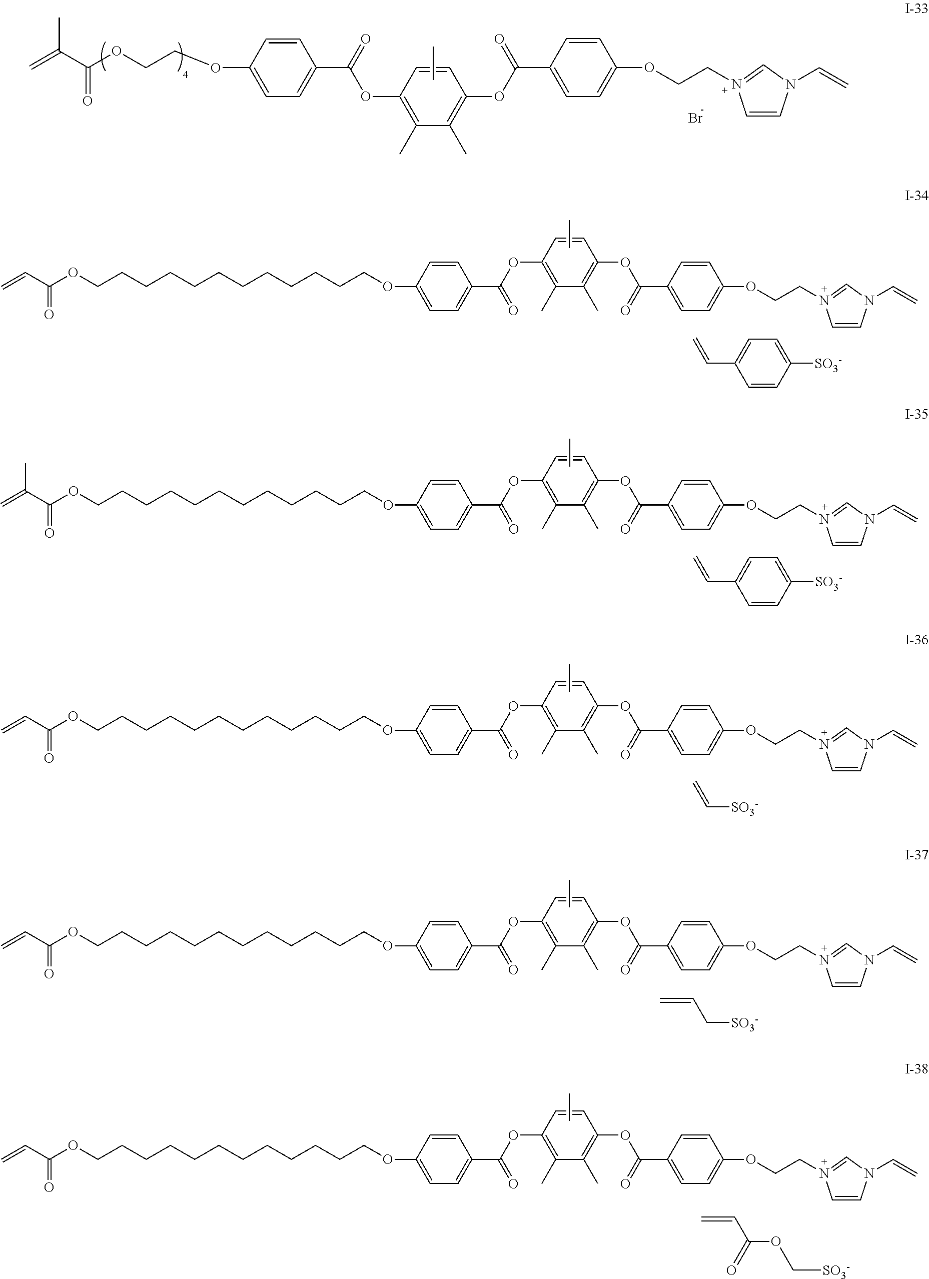

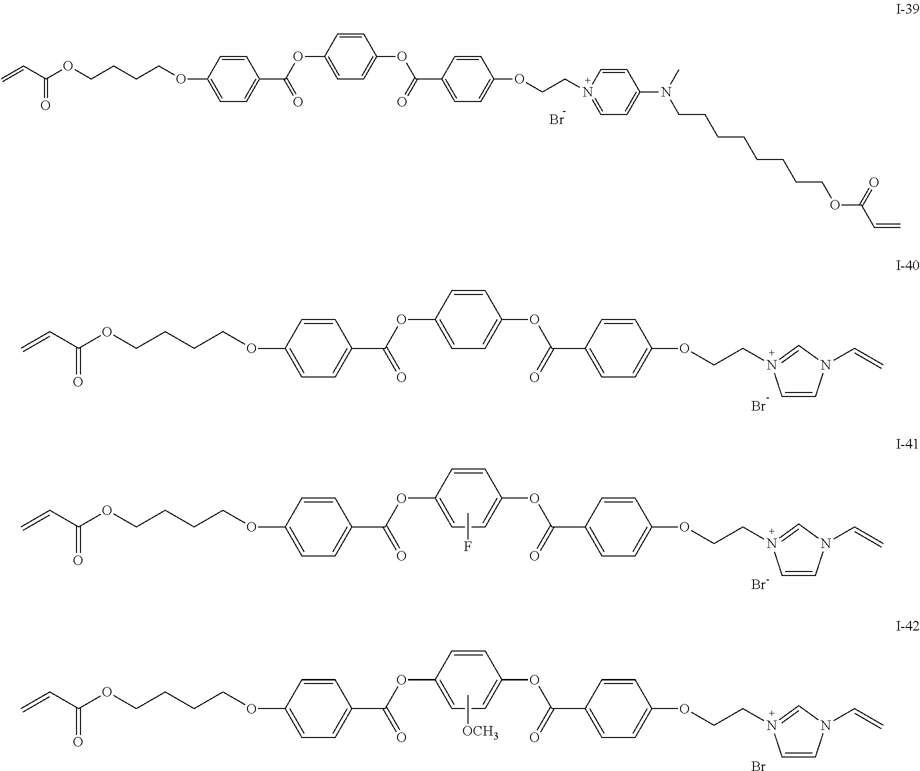

The onium compound represented by formula (I) can be ordinarily synthesized by alkylation (Menschutkin reaction) of a nitrogen-containing hetero ring.

From the standpoint of easiness of causing uneven distribution of the vertical orientation agent to the intermediate layer having a polar group, the retardation layer preferably contains at least one element selected from bromine, boron and silicon. It is more preferred that at least one element selected from bromine, boron and silicon is more unevenly distributed on the side close to the intermediate layer.

With respect to the degree of uneven distribution of the vertical orientation agent to the intermediate layer, a ratio of the vertical orientation agent present at the support side interface of the intermediate layer side to that present at the surface side interface is preferably 3 times or more.

### (Optical Characteristics of Retardation Layer)

The Re value of the retardation layer is preferably from 0 to 3 nm, more preferably from 0 to 2 nm, and still more preferably from 0 to 1 nm

The Rth value of the retardation layer is preferably from −100 to −250 nm, more preferably from −120 to −230 nm, and still more preferably from −140 to −210 nm

The retardation of the retardation layer can be determined by measuring a value of a film prepared by coating the intermediate layer and the retardation layer in this order on a glass plate.

The Re and Rth represent the in-plane retardation value and retardation value in a thickness direction measured with light having a wavelength of 550 nm under conditions of 25° C. and 60% RH, respectively.

### (Thickness of Retardation Layer)

The thickness of retardation layer is preferably from 0.5 to 2.0 μm, more preferably from 1.0 to 2.0 μm, from the standpoint of contributing the reduction in thickness and improving curing of the film.

By providing the retardation layer in which the orientation state of the liquid crystal compound is fixed on the support, the first retardation region which can be used in the invention is obtained.

The first retardation region is preferably provided on the viewing side of the liquid crystal cell.

### [Protective Film for Polarizing Plate]

In the case of using the first retardation region according to the invention as a surface protective film of a polarizing film (protective film for polarizing plate), adhesiveness of the first retardation region to the polarizing film containing polyvinyl alcohol as the main component can be improved by hydrophilizing, specifically, conducting a saponification treatment or UV adhesion described in JP-A-2010-91603, a surface of the support of the first retardation region, namely, a surface on the side to be stuck with the polarizing film.

### [Polarizing Plate]

In the liquid crystal display device according to the invention, the polarizing plate on the viewing side comprises the first polarizing film and protective films for protecting the first polarizing film and at least one of the protective film is the stack (first retardation region) described above.

It is preferred that of the two protective films, one is the first retardation region and the other is a film made of an acrylic resin from the standpoint of curling of the polarizing plate after fabrication of the polarizing plate. The film made of an acrylic resin includes, for example, ACRYPLANE (produced by Mitsubishi Rayon Co., ltd.), TECHNOLLOY (produced by Sumitomo Chemical Co., Ltd.) and SUNDUREN (produced by Kaneka Corp.).

The first retardation region is preferably the protective film on the side of liquid crystal cell.

The first and second polarizing film include an iodine type polarizing film, a dye type polarizing film using a dichromatic dye and a polyene type polarizing film. The iodine type polarizing film and dye type polarizing film are ordinarily produced using a polyvinyl alcohol film.

A constitution is preferred wherein the first retardation region is adhered to the first polarizing film, if desired, for example, through an adhesive layer composed of polyvinyl alcohol, and on the other side of the first polarizing film is disposed a protective film. The other protective film may have an adhesive layer on the side opposite to the side on which the polarizing film is disposed.

The entire thickness of the polarizing plate (total thicknesses of the retardation film, polarizing film and protective film(S)) is preferably from 80 to 120 μm.

In the liquid crystal display device according to the invention, the second retardation region may be provided between the second polarizing film and the liquid crystal cell.

As to the optical characteristics of the second retardation region, a film having the optical characteristics wherein both the Re and Rth values are in the vicinity of 0 is preferred, and a known retardation layer may be employed.

Further, a protective film for polarizing plate may be provided on the side of the second polarizing film opposite to the side on which the second retardation region is provided, and a known protective film for polarizing plate may be employed.

### Examples

The invention will be described in more detail with reference to the examples below. The materials, amounts of use, proportions, contents of treatments, treating procedures and the like described in the examples can be appropriately altered as long as the gist of the invention is not exceeded. Therefore, the scope of the invention should not be construed as being limited to the specific examples described below.

### 1. Production of Support

### (1) Production of Cellulose Acylate Film

Respective cellulose acylate films were produced according to the method described below.

### (1)-1 Preparation of Dope

### Preparation of Cellulose Acylate Solution:

The base compound, additives and solvents shown in the table below were charged into a mixing tank, stirred to dissolve respective components, heated at 90° C. for about 10 minutes, and then filtered through a filter paper having an average pore size of 34 μm and a sintered metallic filter having an average pore size of 10 μm.

The amount of the additive added is indicated by parts by weight to 100 parts by weight of the base compound in the table below. The composition ratio of Solvent 1 and Solvent 2 is indicated by a weight ratio in the table. Also, the solid state concentration (unit: % by weight) of the cellulose acylate solution is described in the column labeled as “Concentration”

### Preparation of Fine Particle Dispersion:

The components shown below including each of the cellulose acylate solutions prepared according to the method described above were charged into a disperser to prepare a fine particle dispersion.

### Fine Particle Dispersion

| | |
|---|---|
| Fine particle (AEROSIL R972, produced by Nippon | 0.2 parts by weight |
| Aerosil Co., Ltd.) | |
| Methylene chloride | 72.4 parts by weight |
| Methanol | 10.8 parts by weight |
| Cellulose acylate solution | 10.3 parts by weight |

The fine particle dispersion was mixed with 100 parts by weight of each of the cellulose acylate solutions in such a manner that the content of the inorganic fine particle to the cellulose acylate was 0.02 parts by weight to prepare a dope for film-formation.

### (1)-2 Casting

The dope was cast using a band casting machine. The band was made of stainless steel.

### (1)-3 Drying

The web (film) formed by casting was peeled from the band and dried at a drying temperature of 120° C. for 20 minutes while transporting by pass roll. The drying temperature as used herein means a surface temperature of the film.

### (1)-4 Stretching

The web (film) obtained was peeled from the band, clipped and stretched in an orthogonal direction (TD) to the transporting direction (MD) of the film using a tenter at the stretching temperature and stretching ratio shown in the table below under condition of fixed-end uniaxial stretching.

(1)-5 Saponification Treatment In the case of performing a saponification treatment, the support was subjected to the saponification treatment in the manner shown below.

The support produced was immersed in an aqueous 2.3 mol/L sodium hydroxide solution at 55° C. for 3 minutes. The support was washed in a water washing bath at room temperature and neutralized using 0.05 mol/L of sulfuric acid. The support was again washed in a water washing bath at room temperature and dried by hot air of 100° C. Thus, the saponification treatment of the support was performed.

TABLE 1

| | Second Retardation Layer | | | | | | | | | | |
|---|---|---|---|---|---|---|---|---|---|---|---|
| | | | | | Additive 2 | | | | | | |
| | | | | | | | Average | Solvent | | | |
| | | | | | | | Carbon | | | Composition | |
| | | | | | | | Number | | | Ratio | Concen- |
| | Base Compound | | Additive 1 | | | | of | | | of | tration |
| | | Substitution | | Amount | | Amount | Carboxylic | | | Solvent 1/ | (% by |
| Example | Kind | Degree | Compound | Added | Compound | Added | Acid | Solvent 1 | Solvent 2 | Solvent 2 | weight) |
| #01 | TAC | 2.43 | RH01 | 3.5 | E-1 | 19 | 6.2 | — | — | Methylene | Methanol |
| | | | | | | | | | | Chloride | |
| #02 | TAC | 2.43 | RH01 | 3.5 | E-1 | 19 | 6.2 | — | — | Methylene | Methanol |
| | | | | | | | | | | Chloride | |
| #03 | TAC | 2.43 | RH01 | 3.5 | E-1 | 19 | 6.2 | — | — | Methylene | Methanol |
| | | | | | | | | | | Chloride | |
| #04 | TAC | 2.43 | RH01 | 3.5 | E-1 | 19 | 6.2 | — | — | Methylene | Methanol |
| | | | | | | | | | | Chloride | |
| #05 | TAC | 2.43 | RH01 | 3.5 | E-1 | 19 | 6.2 | — | — | Methylene | Methanol |
| | | | | | | | | | | Chloride | |
| #06 | TAC | 2.43 | RH01 | 3.5 | E-1 | 19 | 6.2 | — | — | Methylene | Methanol |
| | | | | | | | | | | Chloride | |
| #07 | TAC | 2.43 | RH01 | 3.5 | E-1 | 19 | 6.2 | — | — | Methylene | Methanol |
| | | | | | | | | | | Chloride | |
| #08 | TAC | 2.43 | RH01 | 3.5 | E-1 | 19 | 6.2 | — | — | Methylene | Methanol |
| | | | | | | | | | | Chloride | |
| #09 | TAC | 2.43 | RH01 | 3.5 | E-1 | 19 | 6.2 | — | — | Methylene | Methanol |
| | | | | | | | | | | Chloride | |
| #10 | TAC | 2.43 | RH01 | 3.5 | E-1 | 19 | 6.2 | — | — | Methylene | Methanol |
| | | | | | | | | | | Chloride | |
| #11 | TAC | 2.43 | RH01 | 3.5 | E-1 | 19 | 6.2 | — | — | Methylene | Methanol |
| | | | | | | | | | | Chloride | |
| #12 | TAC | 2.43 | RH01 | 3.5 | E-1 | 19 | 6.2 | — | — | Methylene | Methanol |
| | | | | | | | | | | Chloride | |
| #13 | TAC | 2.43 | RH01 | 3.5 | E-1 | 19 | 6.2 | — | — | Methylene | Methanol |
| | | | | | | | | | | Chloride | |
| #14 | TAC | 2.43 | — | — | E-1 | 19 | 6.2 | — | — | Methylene | Methanol |
| | | | | | | | | | | Chloride | |
| #15 | TAC | 2.43 | RH01 | 8.0 | E-1 | 19 | 6.2 | — | — | Methylene | Methanol |
| | | | | | | | | | | Chloride | |
| #16 | TAC | 2.43 | RH01 | 3.5 | E-1 | 19 | 6.2 | — | — | Methylene | Methanol |
| | | | | | | | | | | Chloride | |
| #17 | TAC | 2.43 | RH01 | 3.5 | E-1 | 19 | 6.2 | — | — | Methylene | Methanol |
| | | | | | | | | | | Chloride | |
| #18 | TAC | 2.43 | RH01 | 3.5 | E-1 | 19 | 6.2 | — | — | Methylene | Methanol |
| | | | | | | | | | | Chloride | |
| #19 | TAC | 1.9 | — | — | E-1 | 19 | 6.2 | — | — | Methylene | Methanol |
| | | | | | | | | | | Chloride | |
| #20 | TAC | 2.68 | RH02 | 8.0 | E-1 | 19 | 6.2 | — | — | Methylene | Methanol |
| | | | | | | | | | | Chloride | |
| #21 | CAP | AC/PR = | — | — | — | — | — | T-1 | 9 | Methylene | Ethanol |
| | | 1.3/0.7 | | | | | | | | Chloride | |
| #22 | ZF | — | — | — | — | — | — | — | — | — | — |
| #23 | TAC | 2.51 | — | -— | E-2 | 9 | 8 | T-2 | 6 | Methylene | Methanol |
| | | | | | | | | | | Chloride | |
| #24 | TAC | 2.43 | RH01 | 5.0 | E-1 | 19 | 6.2 | — | — | Methylene | Methanol |
| | | | | | | | | | | Chloride | |
| #25 | TAC | 2.43 | RH01 | 6.5 | E-1 | 19 | 6.2 | — | — | Methylene | Methanol |
| | | | | | | | | | | Chloride | |
| #26 | TAC | 2.43 | RH02 | 8.0 | E-1 | 19 | 6.2 | — | — | Methylene | Methanol |
| | | | | | | | | | | Chloride | |
| #27 | TAC | 2.43 | RH03 | 4.0 | — | — | — | T-3 | 12 | Methylene | Methanol |
| | | | | | | | | | | Chloride | |
| #28 | TAC | 2.43 | RH02 | 6.0 | — | — | — | — | — | Methylene | Methanol |
| | | | | | | | | | | Chloride | |
| #29 | TAC | 2.43 | RH01 | 3.5 | E-1 | 19 | 6.2 | — | — | Methylene | Methanol |
| | | | | | | | | | | Chloride | |
| #30 | TAC | 2.43 | RH01 | 3.5 | E-1 | 19 | 6.2 | — | — | Methylene | Methanol |
| | | | | | | | | | | Chloride | |
| #31 | TAC | 2.81/2.43/2.81 | RH01 | 3.5 | E-1 | 19 | 6.2 | — | — | Methylene | Methanol |
| | | | | | | | | | | Chloride | |
| #32 | TAC | 2.43 | RH03 | 3.5 | E-3 | 10 | 5.2 | T-1 | 3 | Methylene | Methanol |
| | | | | | | | | | | Chloride | |

| | Second Retardation Layer | | | | | | | | | | |
|---|---|---|---|---|---|---|---|---|---|---|---|
| | Stretching | | Stretching Condition | | | Optical Characteristics | | | | | Saponification |
| | Condition | | Temperature | Ratio | Thickness | Re₁₂ | Rth₁₂ | Rth(450)/ | Rth(650)/ | | Treatment of |
| Example | Temperature (° C.) | Ratio (%) | (° C.) | (%) | (μm) | (nm) | (nm) | Rth(550) | Rth(550) | NZ | Support |
| #01 | 87/13 | 22 | 185 | 67 | 40 | 95 | 96 | 1.00 | 1.00 | 1.51 | NO |
| #02 | 87/13 | 22 | 185 | 67 | 40 | 95 | 96 | 1.00 | 1.00 | 1.51 | NO |
| #03 | 87/13 | 22 | 185 | 67 | 40 | 95 | 96 | 1.00 | 1.00 | 1.51 | NO |
| #04 | 87/13 | 22 | 182 | 57 | 38 | 102 | 98 | 1.00 | 1.00 | 1.46 | NO |
| #05 | 87/13 | 22 | 180 | 57 | 43 | 110 | 118 | 1.00 | 1.00 | 1.57 | NO |
| #06 | 87/13 | 22 | 180 | 55 | 43 | 105 | 120 | 1.00 | 1.00 | 1.64 | NO |
| #07 | 87/13 | 22 | 182 | 56 | 38 | 100 | 109 | 1.00 | 1.00 | 1.59 | NO |
| #08 | 87/13 | 22 | 184 | 64 | 40 | 95 | 100 | 1.00 | 1.00 | 1.55 | NO |
| #09 | 87/13 | 22 | 182 | 59 | 41 | 105 | 110 | 1.00 | 1.00 | 1.55 | NO |
| #10 | 87/13 | 22 | 185 | 70 | 38 | 104 | 98 | 1.00 | 1.00 | 1.44 | NO |
| #11 | 87/13 | 22 | 185 | 67 | 40 | 95 | 96 | 1.00 | 1.00 | 1.51 | NO |
| #12 | 87/13 | 22 | 185 | 67 | 40 | 95 | 96 | 1.00 | 1.00 | 1.51 | NO |
| #13 | 87/13 | 22 | 185 | 67 | 40 | 95 | 96 | 1.00 | 1.00 | 1.51 | NO |
| #14 | 87/13 | 22 | 184 | 80 | 36 | 110 | 100 | 0.94 | 1.06 | 1.41 | NO |
| #15 | 87/13 | 22 | 185 | 85 | 30 | 110 | 100 | 1.11 | 0.91 | 1.41 | NO |
| #16 | 87/13 | 22 | 185 | 67 | 40 | 95 | 96 | 1.00 | 1.00 | 1.51 | NO |
| #17 | 87/13 | 22 | 185 | 67 | 40 | 95 | 96 | 1.00 | 1.00 | 1.51 | NO |
| #18 | 87/13 | 22 | 185 | 67 | 40 | 95 | 96 | 1.00 | 1.00 | 1.51 | NO |
| #19 | 87/13 | 22 | 200 | 70 | 40 | 130 | 140 | 0.97 | 1.03 | 1.58 | NO |
| #20 | 87/13 | 22 | 180 | 70 | 40 | 90 | 90 | 1.03 | 0.98 | 1.50 | NO |
| #21 | 85/15 | 20 | 165 | 75 | 40 | 90 | 90 | 0.98 | 1.02 | 1.50 | NO |
| #22 | — | — | 142 | 120 | 35 | 85 | 75 | 1.00 | 1.00 | 1.38 | NO |
| #23 | 87/13 | 22 | 182 | 70 | 40 | 100 | 95 | 1.02 | 0.98 | 1.45 | NO |
| #24 | 87/13 | 22 | 182 | 70 | 38 | 104 | 98 | 1.03 | 0.97 | 1.44 | NO |
| #25 | 87/13 | 22 | 182 | 70 | 38 | 110 | 100 | 1.05 | 0.96 | 1.41 | NO |
| #26 | 87/13 | 22 | 185 | 80 | 30 | 110 | 100 | 1.11 | 0.91 | 1.41 | NO |
| #27 | 87/13 | 22 | 190 | 75 | 40 | 110 | 100 | 0.99 | 1.01 | 1.41 | YES |
| #28 | 87/13 | 18 | 195 | 75 | 40 | 100 | 108 | 1.01 | 0.99 | 1.58 | NO |
| #29 | 87/13 | 22 | 185 | 67 | 40 | 95 | 96 | 1.00 | 1.00 | 1.51 | NO |
| #30 | 87/13 | 22 | 185 | 67 | 40 | 95 | 96 | 1.00 | 1.00 | 1.51 | YES |
| #31 | 87/13 | 22 | 185 | 67 | 42 | 97 | 96 | 1.00 | 1.00 | 1.49 | NO |
| #32 | 87/13 | 22 | 185 | 67 | 40 | 95 | 96 | 1.00 | 1.00 | 1.51 | NO |

The compounds used are shown below.

In the table, “TAC” denotes cellulose triacetate and the numerical value indicates the substitution degree of acetyl group. “CAP” denotes cellulose acetate propionate having the substitution degree of acetyl group of 1.3 and the substitution degree of propionyl group of 0.7.

The support in Example #31 was a film produced by co-casting cellulose triacetate having the substitution degree of acetyl group of 2.81 as the surface layers on the both sides (front and rear sides) of the base layer composed of cellulose triacetate having the substitution degree of acetyl group of 2.43. The total substitution degree of acetyl group of the cellulose triacetate of Support 31 was 2.45.

“ZF” denotes a cyclic olefin resin having a thickness of 100 μm produced by Zeon Corp.

TABLE 2

| | Diol | | | Dicarboxylic Acid | | | |
|---|---|---|---|---|---|---|---|
| | | | Average | | | | Average |
| | EG | PG | Carbon | TAP | AA | SA | Carbon |
| | (% by mole) | (% by mole) | Number | (% by mole) | (% by mole) | (% by mole) | Number |
| E-1 | 50 | 50 | 2.5 | 55 | 0 | 45 | 6.2 |
| E-2 | 0 | 100 | 3 | 100 | 0 | 0 | 8 |
| E-3 | 50 | 50 | 2.5 | 20 | 20 | 60 | 5.2 |

The weight average molecular weight of each of E-1, E-2 and E-3 was 1,000.
EG: Ethylene glycol
PG: 1,2-Propanediol
TPA: Terephthalic acid
AA: Adipic acid
SA: Succinic acid

T-1 is a compound represented by formula (10) shown below in which five Rs are substituted with substituent (benzoyl group) shown below and the remainder three Rs are hydrogen atoms.

T-2 is a compound represented by formula (10) shown below in which six Rs are substituted with substituent (benzoyl group) shown below and the remainder two Rs are hydrogen atoms.

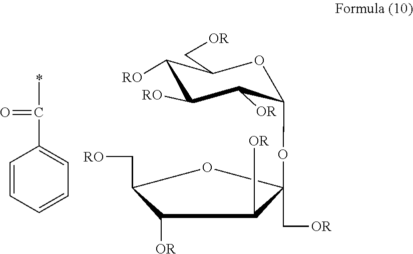

T-3 is a compound having the structure shown below, in which Ac represents an acetyl group.

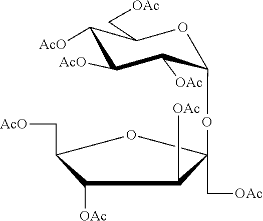

RH01 to RH03 are compounds having the structure shown below.

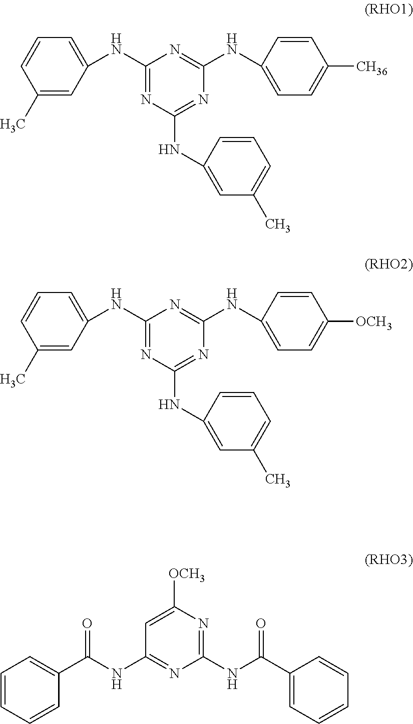

### 2. Formation of Intermediate Layer

The contents and solvents described in the table below were mixed to prepare the composition for forming an intermediate layer.

### (Acrylic Layer)

Two kinds of acrylic compounds (100 parts by weight), 3 parts by weight of a photopolymerization initiator (IRGACURE 127, produced by Ciba Specialty Chemicals Ltd.) and solvents were mixed so as to have the solid content concentration of 20% by weight to prepare a composition for forming an acrylic layer.

As the composition for forming an intermediate layer, the composition for forming an acrylic layer was coated on the support by a wire bar coater of #1.6, dried at 60° C. for 0.5 minutes, and then irradiated with an ultraviolet ray at an illuminance of 40 mW/cm² and a dose of 120 mJ/cm² using a high-pressure mercury lamp under a nitrogen purge at 30° C. and an oxygen concentration of about 0.1% for 30 seconds to cure an intermediate layer.

### (PVA Layer)

Compound (PVA1) represented by formula PVA shown below (100 parts by weight) and 5 parts by weight of T1 shown below were dissolved in a solvent of water:methanol=75:25 (weigh ratio) so as to have the solid content concentration of 2.5% by weight to prepare a composition for forming a PVA layer.

The composition ratio of the content and solvent is indicated by a weight ratio in the table below. Also, a solid content concentration (unit: % by weight) of the composition for forming an intermediate layer is described in the column labeled “Concentration”.

As the composition for forming an intermediate layer, the composition for forming a PVA layer was coated on the support by a wire bar coater of #8 and dried at 60° C. for 0.5 minutes to form an intermediate layer.

The thickness of the intermediate layer prepared is shown in the table below.

TABLE 3

| | | | | Composition | | | Composition | |
|---|---|---|---|---|---|---|---|---|
| | Concentration | | | Ratio of | | | Ratio of | |
| Intermediate | (% by | | | Solvent 1/ | | | Content 1/ | Thickness |
| Layer | weight) | Solvent 1 | Solvent 2 | Solvent 2 | Content 1 | Content 2 | Content 2 | (μm) |
| #01 | 20 | Methyl Acetate | MIBK | 70/30 | ACR1 | ACR2 | 100:50 | 0.5 |
| #02 | 20 | Methyl Acetate | MIBK | 70/30 | ACR1 | ACR2 | 100:50 | 0.5 |
| #03 | 20 | Methyl Acetate | MIBK | 70/30 | ACR1 | ACR2 | 100:50 | 0.5 |
| #04 | 20 | Methyl Acetate | MIBK | 70/30 | ACR1 | ACR2 | 100:50 | 0.5 |
| #05 | 20 | Methyl Acetate | MIBK | 70/30 | ACR1 | ACR2 | 100:50 | 0.5 |
| #06 | 20 | Methyl Acetate | MIBK | 70/30 | ACR1 | ACR2 | 100:50 | 0.5 |
| #07 | 20 | Methyl Acetate | MIBK | 70/30 | ACR1 | ACR2 | 100:50 | 0.5 |
| #08 | 20 | Methyl Acetate | MIBK | 70/30 | ACR1 | ACR2 | 100:50 | 0.5 |
| #09 | 20 | Methyl Acetate | MIBK | 70/30 | ACR1 | ACR2 | 100:50 | 0.5 |
| #10 | 20 | Methyl Acetate | MIBK | 70/30 | ACR1 | ACR2 | 100:50 | 0.5 |
| #11 | 20 | Methyl Acetate | MIBK | 70/30 | ACR1 | ACR2 | 100:50 | 0.5 |
| #12 | 20 | Methyl Acetate | MIBK | 70/30 | ACR1 | ACR2 | 100:50 | 0.5 |
| #13 | 20 | Methyl Acetate | MIBK | 70/30 | ACR1 | ACR2 | 100:50 | 0.5 |
| #14 | 20 | Methyl Acetate | MIBK | 70/30 | ACR1 | ACR2 | 100:50 | 0.5 |
| #15 | 20 | Methyl Acetate | MIBK | 70/30 | ACR1 | ACR2 | 100:50 | 0.5 |
| #16 | 20 | Methyl Acetate | MIBK | 70/30 | ACR1 | ACR2 | 100:50 | 0.5 |
| #17 | 20 | Methyl Acetate | MIBK | 70/30 | ACR1 | ACR2 | 100:50 | 0.5 |
| #18 | 20 | Methyl Acetate | MIBK | 70/30 | ACR1 | ACR2 | 100:50 | 0.5 |
| #19 | 20 | Methyl Acetate | MIBK | 70/30 | ACR1 | ACR2 | 100:50 | 0.5 |
| #20 | 20 | Methyl Acetate | MIBK | 70/30 | ACR1 | ACR2 | 100:50 | 0.5 |
| #21 | 20 | Methyl Acetate | MIBK | 60/40 | ACR1 | ACR2 | 100:50 | 0.5 |
| #22 | 20 | Cyclohexanone | MEK | 70/30 | ACR1 | ACR2 | 100:50 | 0.5 |
| #23 | 20 | Methyl Acetate | MIBK | 70/30 | ACR1 | ACR2 | 100:50 | 0.5 |
| #24 | 20 | Methyl Acetate | MIBK | 70/30 | ACR1 | ACR2 | 100:50 | 0.5 |
| #25 | 20 | Methyl Acetate | MIBK | 70/30 | ACR1 | ACR2 | 100:50 | 0.5 |
| #26 | 20 | Methyl Acetate | MIBK | 70/30 | ACR1 | ACR2 | 100:50 | 0.5 |
| #27 | 20 | Methyl Acetate | MIBK | 70/30 | ACR1 | ACR2 | 100:50 | 0.5 |
| #28 | 20 | Methyl Acetate | MIBK | 70/30 | ACR1 | ACR2 | 100:50 | 0.5 |
| #29 | 20 | Methyl Acetate | MIBK | 70/30 | ACR1 | ACR2 | 100:50 | 0.5 |
| #30 | PVA Layer | | | | | | | 0.25 |
| #31 | 20 | Methyl Acetate | MIBK | 70/30 | ACR1 | ACR2 | 100:50 | 0.5 |
| #32 | 20 | Methyl Acetate | MIBK | 70/30 | ACR1 | ACR2 | 100:50 | 0.5 |

The compounds used are shown below.
MIBK: Methyl isobutyl ketone 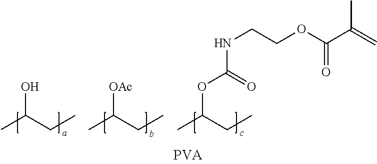
a, b and c each represents a molar ratio of each unit.
PVA 1 is a compound represented by formula PVA shown above wherein a is 96, b is 2 and c is 2. 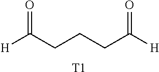
ACR1: BLEMMER GLM (produced by NOF Corp.), compound having the structure shown below: 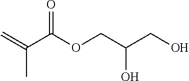
ARC2: KAYARAD PET30 (produced by Nippon Kayaku Co., Ltd.), compound having the structure shown below:

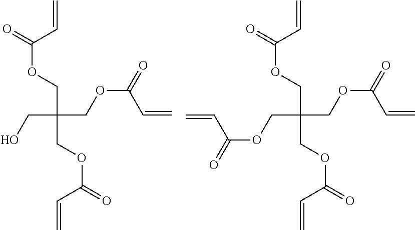

### 3. Formation of Retardation Layer

On the intermediate layer was coated by a wire bar of #3.2 a solution prepared by dissolving 1.8 g of liquid crystal compound (mixture containing Compound 1 and Compound 2 shown in the table below in a composition ratio (weight ratio) shown in the table below), 0.06 g of a photopolymerization initiator (IRGACURE 907, produced by Ciba Geigy Co., Ltd.), 0.02 g of a sensitizer (KAYACURE DETX produced by Nippon Kayaku Co., Ltd.), 0.002 g of a vertical orientation agent (S01) and an acrylic compound in a ratio to the liquid crystal compound as shown in Table 4 in methyl ethyl ketone (MEK)/cyclohexanone (86/14% by weight). The resulting coating was stuck to a metal frame and heated in a thermostatic bath of 100° C. for 2 minutes to orient the rod-like liquid crystal compound (homeotropic orientation). The stack was cooled to 50° C. and irradiated with an ultraviolet ray at an illuminance of 190 mW/cm² and a dose of 300 mJ/cm² using an air-cooled metal halide lamp (produced by Eye Graphics Co., Ltd.) under a nitrogen purge at an oxygen concentration of about 0.1% to cure the coated layer and then allowed to cool to room temperature.

TABLE 4

| | | | | | | | | | | | Total |
|---|---|---|---|---|---|---|---|---|---|---|---|
| | | | | | | | | | | | Thickness |
| | Liquid Crystal Compound | | | | Amount of | | Optical | | | | of First |
| | | | Composition Ratio of | Vertical | Acrylic | | Characteristics | | Wavelength Dispersion | | Retardation |
| | Compound | Compound | Compound1/Compound | Orientation | Compound | Thickness | Re₁₁ | Rth₁₁ | Rth₁₁(450)/ | Rth₁₁(650)/ | Region |
| | 1 | 2 | 2 | Agent | (%) | (μm) | (nm) | (nm) | Rth₁₁(550) | Rth₁₁(550) | (μm) |
| #01 | LC01 | LC02 | 9:1 | Present | 8 | 1.6 | 0.1 | −180 | 1.09 | 0.95 | 42 |
| #02 | LC01 | LC02 | 9:1 | Present | 8 | 1.5 | 0.1 | −170 | 1.09 | 0.95 | 42 |
| #03 | LC01 | LC02 | 9:1 | Present | 8 | 1.4 | 0.1 | −155 | 1.09 | 0.95 | 42 |
| #04 | LC01 | LC02 | 9:1 | Present | 8 | 1.4 | 0.1 | −155 | 1.09 | 0.95 | 40 |
| #05 | LC01 | LC02 | 9:1 | Present | 8 | 1.4 | 0.1 | −155 | 1.09 | 0.95 | 45 |
| #06 | LC01 | LC02 | 9:1 | Present | 8 | 1.5 | 0.1 | −170 | 1.09 | 0.95 | 45 |
| #07 | LC01 | LC02 | 9:1 | Present | 8 | 1.0 | 0.1 | −115 | 1.09 | 0.95 | 40 |
| #08 | LC01 | LC02 | 9:1 | Present | 8 | 1.2 | 0.1 | −130 | 1.09 | 0.95 | 42 |
| #09 | LC01 | LC02 | 9:1 | Present | 8 | 1.4 | 0.1 | −155 | 1.09 | 0.95 | 43 |
| #10 | LC01 | LC02 | 9:1 | Present | 8 | 1.4 | 0.1 | −155 | 1.09 | 0.95 | 40 |
| #11 | LC01 | LC02 | 9:1 | Present | 8 | 1.4 | 0.1 | −155 | 1.09 | 0.95 | 42 |
| #12 | LC01 | LC02 | 9:1 | Present | 8 | 1.7 | 0.1 | −185 | 1.09 | 0.95 | 42 |
| #13 | LC01 | LC02 | 9:1 | Present | 8 | 1.4 | 0.1 | −155 | 1.09 | 0.95 | 42 |
| #14 | LC01 | LC02 | 9:1 | Present | 8 | 1.3 | 0.1 | −140 | 1.09 | 0.95 | 38 |
| #15 | LC01 | LC02 | 9:1 | Present | 8 | 1.3 | 0.1 | −140 | 1.09 | 0.95 | 32 |
| #16 | LC01 | LC02 | 9:1 | Present | 25 | 2.5 | 0.0 | −140 | 1.04 | 0.99 | 43 |
| #17 | LC03 | — | 10:0 | Present | 0 | 1.3 | 0.1 | −155 | 1.16 | 0.89 | 42 |
| #18 | — | — | — | — | — | — | — | — | — | — | 41 |
| #19 | LC01 | LC02 | 9:1 | Present | 8 | 1.4 | 0.1 | −182 | 1.09 | 0.95 | 42 |
| #20 | LC01 | LC02 | 9:1 | Present | 8 | 1.2 | 0.1 | −155 | 1.09 | 0.95 | 42 |
| #21 | LC01 | LC02 | 9:1 | Present | 8 | 1.3 | 0.1 | −165 | 1.09 | 0.95 | 42 |
| #22 | LC01 | LC02 | 9:1 | Present | 8 | 1.2 | 0.1 | −155 | 1.09 | 0.95 | 37 |
| #23 | LC01 | LC02 | 9:1 | Present | 8 | 1.2 | 0.1 | −155 | 1.09 | 0.95 | 42 |
| #24 | LC01 | LC02 | 9:1 | Present | 8 | 1.2 | 0.1 | −155 | 1.09 | 0.95 | 40 |
| #25 | LC01 | LC02 | 9:1 | Present | 8 | 1.2 | 0.1 | −155 | 1.09 | 0.95 | 40 |
| #26 | LC01 | LC02 | 9:1 | Present | 8 | 1.2 | 0.1 | −155 | 1.09 | 0.95 | 32 |
| #27 | LC01 | LC02 | 9:1 | Present | 8 | 1.2 | 0.1 | −155 | 1.09 | 0.95 | 42 |
| #28 | LC01 | LC02 | 9:1 | Present | 8 | 1.2 | 0.1 | −155 | 1.09 | 0.95 | 42 |
| #29 | LC01 | — | 10:0 | Present | 8 | 1.1 | 0.1 | −140 | 1.09 | 0.95 | 42 |
| #30 | LC01 | LC02 | 9:1 | Present | 8 | 1.1 | 0.1 | −140 | 1.09 | 0.95 | 41 |
| #31 | LC01 | LC02 | 9:1 | Present | 8 | 1.2 | 0.1 | −155 | 1.09 | 0.95 | 44 |
| #32 | LC01 | LC02 | 9:1 | Present | 8 | 1.2 | 0.1 | −155 | 1.09 | 0.95 | 42 |

The compounds used are shown below.
(LC01) 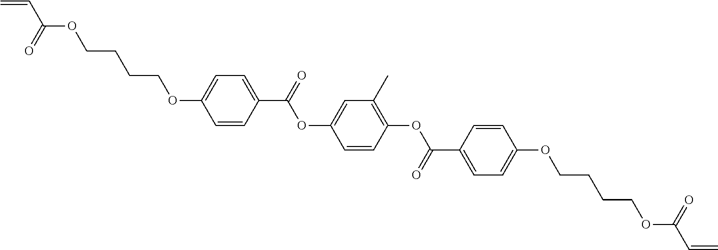 [SMILES: C=CC(=O)OCCCCOc1ccc(C(=O)Oc2ccc(OC(=O)c3ccc(OCCCCOC(=O)C=C)cc3)c(C)c2)cc1]
(LC02) 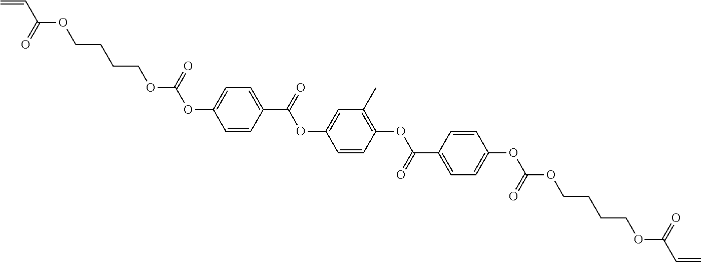 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]
(LC03) 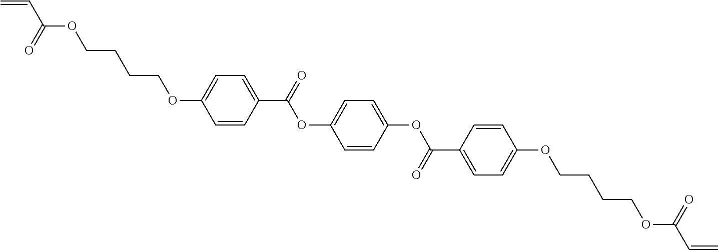 [SMILES: C=CC(=O)OCCCCOc1ccc(C(=O)Oc2ccc(OC(=O)c3ccc(OCCCCOC(=O)C=C)cc3)cc2)cc1]
(Vertical orientation agent) 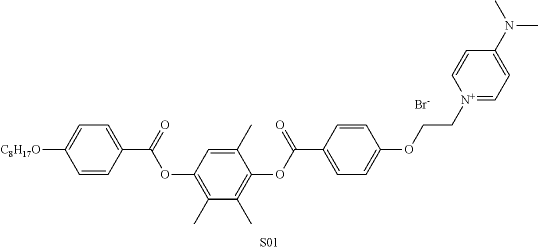
(Acrylic compound)
VISCOTE 360 (produced by Osaka Organic Chemical Industry Ltd.) 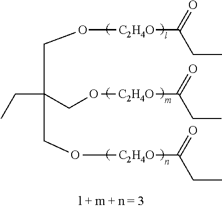
“Acrylic Compound” in Table 4 is VISCOTE 360 described above.
ACR1: KAYARAD PET30 (produced by Nippon Kayaku Co., Ltd.)(mixture of pentaerythritol triacrylate/pentaerythritol tetraacrylate) 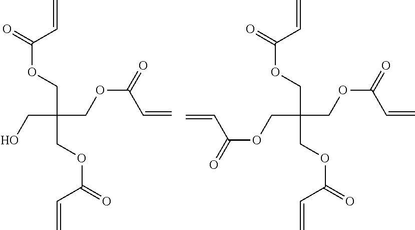
ACR2: BLEMMER GLM (produced by NOF Corp.)

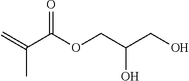

Thus, the respective retardation films of stack type having the retardation layer in which the oriented state of liquid crystal compound was fixed in a homeotropic orientation on the intermediate layer were produced.

### <Evaluation of Retardation Film>

With respect to the retardation films obtained, a thickness, Re, Rth, and |Rth/Re| were evaluated.

### 4. Production of Polarizing Plate

Each retardation film produced above was stuck on a polyvinyl alcohol polarizer using an adhesive, and a FUJITAC TD60UL film (having a thickness of 60 μm) produced by FUJIFILM Corp. was similarly stuck on the other surface of the polarizer to produce a polarizing plate. At the time of sticking the retardation film and the polarizer, the surface of cellulose acylate film of the support was stuck on the surface of polarizer.

At the time of mounting the polarizing plate on the liquid crystal display device, the polarizing plate was arranged so that the retardation film was disposed between the liquid crystal cell and the polarizer.

The polarizing plate produced above was used as a display side polarizing plate as described below. As a back light side polarizing plate used in combination with the display side polarizing plate, a polarizing plate produced by sticking a Z-TAC film produced by FUJIFILM Corp. on one surface of a polarizer and a FUJITAC TD60UL film (having a thickness of 60 μm) produced by FUJIFILM Corp. on the other side of the polarizer was employed. At the time of mounting the polarizing plate on the liquid crystal display device, the polarizing plate was arranged so that the Z-TAC film was disposed between the liquid crystal cell and the polarizer.

### 5. Production and Evaluation of Liquid Crystal Display Device

Each of the polarizing plates having the retardation film of stack type produced above was mounted on the display side of an IPS mode liquid crystal cell (d·Δn value of liquid crystal layer: 300 nm) and the polarizing plate having the Z-TAC film produced above was mounted on the backlight side of the IPS mode liquid crystal cell to produce an IPS mode liquid crystal display device.

### <Evaluation of Liquid Crystal Display Device>

### (Preparation of IPS Type Liquid Crystal Cell)

On one glass substrate were arranged electrodes so as to have a distance of 20 μm between the adjacent electrodes, then a polyimide film was provided thereon as an oriented film and subjected to a rubbing treatment. A polyimide film was provided on one surface of another glass substrate and subjected to a rubbing treatment to prepare an oriented film. Two glass substrates were stuck with facing respective oriented films in such a manner to make the rubbing directions parallel to each other, a nematic liquid crystal composition having a refractive index anisotropy (Δn) of 0.0889 and a dielectric constant anisotropy (Δ∈) of +4.5 was injected therebetween and a cell gap d was set to 3.5 μm to produce a liquid crystal cell having a Δn·d of 311 nm. The pretilt angle was set to 1°.

With varying the cell gap d of the liquid crystal cell, Cells 1 to 8 having different Δn·d values were produced in the manner as described above.

TABLE 5

| | Refractive | | | |
|---|---|---|---|---|
| | Index | | Cell Gap (d) | |
| | Anisotropy | Δε | (μm) | Δn · d_{b} |
| Cell 1 | 0.0889 | 4.5 | 3 | 267 |
| Cell 2 | 0.0889 | 4.5 | 3.2 | 284 |
| Cell 3 | 0.0889 | 4.5 | 3.5 | 311 |
| Cell 4 | 0.0889 | 4.5 | 3.62 | 322 |
| Cell 5 | 0.0889 | 4.5 | 4 | 356 |
| Cell 6 | 0.0889 | 4.5 | 4.4 | 391 |
| Cell 7 | 0.0889 | 4.5 | 5 | 445 |
| Cell 8 | 0.0889 | 4.5 | 5.2 | 462 |

### (5) Production of Liquid Crystal Display Device

The polarizing plate having the retardation layer was stuck on the display side surface of the IPS mode liquid crystal cell in such a manner that the in-plane slow axis direction of the retardation layer was consistent with the rubbing direction (for example, direction 4 in FIG. 2) of the liquid crystal cell.

Thus, an IPS mode liquid crystal display device LCD was produced. As a backlight device, a backlight unit obtained by destruction of iPad 2 (trade name) produced by Apple Inc. was used.

### (6) Evaluation of Liquid Crystal Display Device

With respect to the liquid crystal display device thus-produced, the evaluations described below were conducted. The Δnd_{w} was calculated at 275 nm corresponding to a half wavelength of 550 nm which was an approximately center value of visible light region (400 to 700 nm).

### (White Brightness)

The viewing angle characteristic of white brightness was measured by using a contrast measurement device (EZContrast produced by ELDIM Co.) and evaluated according to the criteria shown below.

A: 450 cd/m² or more
B: 430 cd/m² or more
C: 410 cd/m² or more
D: 390 cd/m² or more

### (Gradation Inversion Property)

Using a pattern generator, a black display (0 gradation) and a neutral tone display (23 gradation) was displayed at the time when the gradation was divided into 255 from a black display as 0 gradation to a white display as 255 gradation.

Further, the viewing angle characteristics of brightness Y (L0) at the black display and brightness Y (L23) at the neutral tone display were measured by using a contrast measurement device (EZContrast produced by ELDIM Co.) and evaluated according to the criteria shown below.

A: Y(L0)<Y(L23) at all viewing angles
B: Angle region which satisfies Y(L0)<Y(L23) is from 95% to less than 100% of all viewing angles.
C: Angle region which satisfies Y(L0)<Y(L23) is from 90% to less than 95% of all viewing angles.
D: Angle region which satisfies Y(L0)<Y(L23) is less than 90% of all viewing angles.
(Black brightness X, Black Brightness Y, Black Brightness Z)

The viewing angle characteristics Y, x, y of black tint were measured by using a contrast measurement device (EZContrast produced by ELDIM Co.) to calculate X and Z according to Formula (1) and Formula (2) and evaluated according to the criteria shown below.

x=X/(X+Y+Z) Formula (1)

y=Y/(X+Y+Z) Formula (2)

After the calculation, based on the maximum value in all viewing angles, the evaluation was conducted according to the criteria shown below.

### X

A: less than 0.95

B: from 0.95 to less than 1.15

C: from 1.15 to less than 1.35

D: 1.35 or more

### Y

A: less than 0.75

B: from 0.75 to less than 0.95

C: from 0.95 to less than 1.15

D: 1.15 or more

### Z

A: less than 2.50

B: from 2.50 to less than 3.50

C: from 3.50 to less than 4.50

D: 4.50 or more

The evaluation results are shown in the table below. In the table, #n indicates a number of the liquid crystal display device having the support #n, intermediate layer #n and retardation layer #n and n represents from 01 to 32.

TABLE 6

| | | | | | | Gradation | | | | |
|---|---|---|---|---|---|---|---|---|---|---|
| | Cell | | | (Δnd_{b} − Δnd_{w})/ | White | Inversion | Black | Black | Black | |
| | No. | Δnd_{b} | (Δnd_{b} − Δnd_{w})/2 | (2 · (\|Rth₁₁\| − \|Rth₁₂\|)) | Brightness | Property | Brightness X | Brightness Y | Brightness Z | |
| #01 | Cell 5 | 356 | 40 | 0.48 | A | C | C | D | D | Comparative |
| | | | | | | | | | | Example |
| #02 | Cell 5 | 356 | 40 | 0.54 | A | B | B | B | B | Example |
| #03 | Cell 5 | 356 | 40 | 0.68 | A | A | A | B | A | Example |
| #04 | Cell 5 | 356 | 40 | 0.71 | A | A | A | A | A | Example |
| #05 | Cell 5 | 356 | 40 | 1.09 | A | C | C | D | D | Comparative |
| | | | | | | | | | | Example |
| #06 | Cell 5 | 356 | 40 | 0.81 | A | C | C | C | D | Comparative |
| | | | | | | | | | | Example |
| #07 | Cell 2 | 284 | 5 | 0.79 | C | B | B | B | B | Example |
| #08 | Cell 3 | 311 | 18 | 0.60 | B | A | B | B | B | Example |
| #09 | Cell 4 | 322 | 23 | 0.52 | A | A | A | A | B | Example |
| #10 | Cell 5 | 356 | 40 | 0.71 | A | A | A | A | A | Example |
| #11 | Cell 6 | 391 | 58 | 0.98 | A | B | A | B | A | Example |
| #12 | Cell 7 | 445 | 85 | 0.95 | C | B | B | B | C | Example |
| #13 | Cell 8 | 462 | 94 | 1.59 | D | D | C | C | C | Comparative |
| | | | | | | | | | | Example |
| #14 | Cell 4 | 322 | 23 | 0.59 | A | A | A | B | B | Example |
| #15 | Cell 4 | 322 | 23 | 0.59 | A | A | B | B | A | Example |
| #16 | Cell 5 | 365 | 40 | 0.92 | A | B | A | A | B | Example |
| #17 | Cell 5 | 365 | 40 | 0.68 | A | A | B | B | B | Example |
| #18 | Cell 5 | 365 | 40 | −0.42 | A | D | D | D | D | Comparative |
| | | | | | | | | | | Example |
| #19 | Cell 5 | 365 | 40 | 0.96 | A | B | A | A | B | Example |
| #20 | Cell 5 | 365 | 40 | 0.62 | A | A | A | A | B | Example |
| #21 | Cell 5 | 365 | 40 | 0.54 | A | A | A | B | B | Example |
| #22 | Cell 5 | 365 | 40 | 0.50 | A | A | A | B | B | Example |
| #23 | Cell 5 | 365 | 40 | 0.67 | A | A | A | A | A | Example |
| #24 | Cell 5 | 365 | 40 | 0.71 | A | A | A | A | A | Example |
| #25 | Cell 5 | 365 | 40 | 0.73 | A | A | A | A | A | Example |
| #26 | Cell 5 | 365 | 40 | 0.73 | A | A | A | A | A | Example |
| #27 | Cell 5 | 365 | 40 | 073 | A | A | A | A | A | Example |
| #28 | Cell 5 | 365 | 40 | 0.86 | A | B | B | B | B | Example |
| #29 | Cell 5 | 365 | 40 | 0.92 | A | B | A | A | A | Example |
| #30 | Cell 5 | 365 | 40 | 0.92 | A | B | A | A | A | Example |
| #31 | Cell 5 | 365 | 40 | 0.68 | A | A | A | A | A | Example |
| #32 | Cell 5 | 365 | 40 | 0.68 | A | A | A | A | A | Example |

What is claimed is:

1. A liquid crystal display device comprising:
a first polarizing film;
a first retardation region;
a liquid crystal cell which comprises a liquid crystal layer sandwiched between a pair of substrates, in which liquid crystal molecules in the liquid crystal layer are oriented parallel to surfaces of the pair of substrates at a time of black display; and
a second polarizing film,
wherein a slow axis of the first retardation region is arranged orthogonally or parallel to a long axis of the liquid crystal molecule at a surface of the liquid crystal layer at a side of the substrate of the liquid crystal cell adjacent to the first retardation region in a state of no application of voltage,
the liquid crystal cell operates in a lateral electric field mode, and
the first retardation region comprises a first retardation layer and a second retardation layer having retardation values different from each other and satisfies the following formulae 1) and 2):
0.5×(|Rth₁₁|−|Rth₁₂|)≦|Δnd_{b}−Δnd_{w}|/2≦(|Rth₁₁−|Rth₁₂|) Formula 1)
1.3≦|Rth₁₂|/|Re₁₂|+0.5≦1.6 Formula 2)
wherein Δnd_{b} is a retardation value at a wavelength of 550 nm of the liquid crystal cell at a time of black display, Δnd is a retardation value at a wavelength of 550 nm of the liquid crystal cell at a time of white display, Rth₁₁ is a retardation value at a wavelength of 550 nm in a thickness direction of the first retardation layer, and Re₁₂ and Rth₁₂ are a retardation value at a wavelength of 550 nm in an in-plane direction and a retardation value at a wavelength of 550 nm in a thickness direction of the second retardation layer, respectively.

2. The liquid crystal display device as claimed in claim 1, wherein the retardation value of the liquid crystal cell at a time of black display Δnd_{b} satisfies 275 nm<Δnd_{b}<450 nm.

3. The liquid crystal display device claimed in claim 2, wherein the retardation value of the liquid crystal cell at a time of black display Δnd_{b} satisfies 320 nm<Δnd_{b}<400 nm.

4. The liquid crystal display device as claimed in claim 1, wherein the liquid crystal cell satisfies the following formulae 3) and 4):
1.0≦Δnd_{b}(450)/Δnd_{b}(550)≦1.6 Formula 3)
0.5≦Δnd_{b}(650)/Δnd_{b}(550)≦1.0 Formula 4)
wherein Δnd_{b}(λ) is a retardation value of the liquid crystal cell at a time of black display at a measuring wavelength λ (nm).

5. The liquid crystal display device as claimed in claim 1, wherein the first retardation layer satisfies the following formulae 5) and 6):
1.05≦Rth₁₁(450)/Rth₁₁(550)≦1.15 Formula 5)
0.90≦Rth₁₁(650)/Rth₁₁(550)≦0.98 Formula 6)
wherein Rth₁₁(λ) is a retardation value in a thickness direction of the first retardation layer at a measuring wavelength λ (nm).

6. The liquid crystal display device as claimed in claim 1, wherein the second retardation layer satisfies the following formulae 7) and 8):
0.95≦Rth₁₂(450)/Rth₁₂(550)≦1.10 Formula 7)
0.90≦Rth₁₂(650)/Rth₁₂(550)≦1.05 Formula 8)
wherein Rth₁₂(λ) is a retardation value in a thickness direction of the second retardation layer at a measuring wavelength λ (nm).

7. The liquid crystal display device as claimed in claim 1, wherein the first retardation layer and second retardation layer have retardation values satisfying Rth₁₁<0 and Rth₁₂>0, respectively.

8. The liquid crystal display device as claimed in claim 1, wherein the first retardation region further comprises a layer having no retardation between the first retardation layer and the second retardation layer.

9. The liquid crystal display device as claimed in claim 1, wherein the first retardation region comprises: a layer containing a cellulose acylate having an average acyl group substitution degree DS satisfying 2.0<DS<2.6, as a main component; a layer containing a polyvinyl alcohol resin or an acrylic resin having a polar group; and a layer in which a homeotropically oriented liquid crystal compound is fixed in an oriented state.

10. The liquid crystal display device as claimed in claim 1, wherein the first retardation region has a total thickness of from 20 to 50 μm.

11. The liquid crystal display device as claimed in claim 1, wherein a thickness of each of the first polarizing film and second polarizing film is from 3 to 15 μm.

12. The liquid crystal display device as claimed in claim 1, which further comprises a protective film disposed at a side, opposite to the liquid crystal cell, of the first polarizing film, and a total thickness of a polarizing plate comprising the protective film, the first polarizing film and the first retardation region is from 80 to 120 μm.
